(19) United States
(12) Patent Application Publication
(10) Pub. No.: US 2026/0003922 A1
(43) Pub. Date: Jan. 1, 2026

(54) METHOD AND APPARATUS FOR SEARCHING COLLECTED UTILITY INSPECTION READINGS

(71) Applicant: Hydromax USA, LLC, Evansville, IN (US)

(72) Inventors: David STIGER, Evansville, IN (US); Saliya KIRIGEEGANAGE, Louisville, KY (US); Adam Fredrick STEWART, Louisville, KY (US); Jacob W. BERG, Vine Grove, KY (US)

(73) Assignee: Hydromax USA, LLC, Evansville, IN (US)

(21) Appl. No.: 18/822,587

(22) Filed: Sep. 3, 2024

Related U.S. Application Data
(60) Provisional application No. 63/665,655, filed on Jun. 28, 2024.

(51) Int. Cl. G06F 16/9537; G06F 16/23; G06F 16/9538

(52) U.S. Cl. CPC G06F 16/9537; G06F 16/2379; G06F 16/9538

(57) ABSTRACT

The present disclosure discusses a computer program product or inspection protocol that enables automatic, real-time collection of conveyance readings for a specific utility being measured and a precise geolocation of each conveyance reading without any intervention by the technician. The present disclosure also discusses that the computer program product processes and generates a set of breadcrumbs based on collection of conveyance readings for a specific utility and the geolocations of the conveyance readings as well as validating each breadcrumb based on the spatial position of the breadcrumb relative to a surveyed utility line. The present disclosure also discusses that the computer program product indexes and searches for one or more breadcrumbs generated for a particular utility line based one or more parameters inputted into the computer program product by a user.

### REFERENCE TO RELATED APPLICATIONS

This application claims the benefit of U.S. Provisional Application Ser. No. 63/665,655 filed on Jun. 28, 2024; the disclosure of which is incorporated herein by reference.

### TECHNICAL FIELD

This disclosure is directed to method and computer program product that automatically generates a utility survey record.

### BACKGROUND ART

Utility surveys and inspections play a critical role in various industries, including construction, infrastructure development, and urban planning. Utility surveys and inspections help identify and map utilities (both underground and above-ground) carrying conveyances, such as water, gas, electricity, and other conveyances. By knowing the precise locations, construction teams may avoid accidental damage during excavation or construction work. Utility surveys and inspections also enhance the safety of workers in these areas. Particularly, knowledge or awareness of one or more utilities by construction crews may take the necessary precautions to prevent accidents or injuries to themselves as well as others located near such utilities. By performing these utility surveys, the surveyed conveyance being carried inside utilities are monitored to prevent damage or disruptions to existing conveyances that may reduce repair costs and minimize service interruptions. Moreover, such utility surveys also provide environmental protection to mitigate ecological hazards that may lead to pollution, including gas leaks, chemical spills, water source contamination, and other similar ecological hazards.

While such utility surveys exist and are practiced, conventional utility surveys have detriments that lead to less efficient and ineffective results. Conventionally, utility surveyors or operators must physically survey and record a plurality of utilities carrying conveyances, such as water, gas, or electrical lines. In some instances, utility surveyors or technicians may inaccurately collect and record data due to various situations, either through incidentally recording the wrong information or purposefully recording data that is inaccurate for failing to survey such utilities. With such inaccuracy, construction crews, residents, and other near or proximate to these utilities may be at risk for not being aware of or know of potential utility risks. Further, such utility surveyors or technicians may also falsify data or information due to such surveyors or technicians failing to survey one or more utilities in a given area; with this, there is a lack of accountability with respect to surveyors or technicians for performing such tasks of surveying and inspecting utilities.

### SUMMARY OF THE INVENTION

As such, there is a need for automatic, real-time collection of data without manually inputting or recording readings for a surveyed utility. The present disclosure discusses a computer program product or inspection protocol that enables automatic, real-time collection of conveyance readings for a specific utility being measured and a precise geolocation of each conveyance reading without any intervention by the technician. The present disclosure also discusses that the computer program product processes and generates a set of breadcrumbs based on collection of conveyance readings for a specific utility and the geolocations of the conveyance readings as well as validating a surveyed utility based on the spatial position of the breadcrumb relative to the surveyed utility. The present disclosure also discusses that the computer program product indexes and searches for one or more breadcrumbs generated for a particular utility line based one or more parameters inputted into the computer program product by a user.

In one aspect, an exemplary embodiment of the present disclosure may provide a method of collecting a set of conveyance readings along a utility. The method includes steps of: connecting a utility detector to a mobile device; connecting a global positioning system (GPS) unit to the mobile device; measuring for a conveyance that is conveyed by the utility line, by the utility detector, in real-time, wherein the conveyance is contained inside of the utility or escaped from the utility; recording each geolocation of the measured conveyance, by the GPS unit, in real-time; and collecting the set of conveyance readings of the utility from the utility detector and the GPS unit by a computer program product installed on the mobile device.

This exemplary embodiment or another exemplary embodiment may further include that the step of measuring for the conveyance that is carried inside of the utility, by the utility detector, in real-time further includes that the measuring the utility that is carried inside of the utility is performed at a predetermined time interval prior to measuring said conveyance; and wherein the step of recording each geolocation of the measured conveyance, by the GPS unit, in real-time further includes that the recording of the measured conveyance is performed at the predetermined time interval prior to recording each geolocation. This exemplary embodiment or another exemplary embodiment may further include that the step of measuring for the conveyance that is carried inside of the utility, by the utility detector, in real-time further includes that the measuring the conveyance that is carried inside of the utility is performed at a starting point prior to measuring said conveyance; and wherein the step of recording each geolocation of the measured conveyance, by the GPS unit, in real-time further includes that the recording of the measured conveyance is performed at the predetermined starting point prior to recording each geolocation. This exemplary embodiment or another exemplary embodiment may further include steps of selecting a utility project from the computer program product installed on the mobile device; saving measured conveyance readings and geolocations to the selected utility project. This exemplary embodiment or another exemplary embodiment may further include steps of accessing application programming interface (API) from the mobile device; and accessing a database having a set of conveyance parameters related to the selected utility project. This exemplary embodiment or another exemplary embodiment may further include a step of recording a profile of an inspector on the API from the mobile device that is operating the utility detector and the GPS unit. This exemplary embodiment or another exemplary embodiment may further include a step of setting the utility detector to a conveyance measurement threshold based on the selected utility project. This exemplary embodiment or another exemplary embodiment may further include a step of setting time intervals of the collected conveyance readings based on the selected utility project. This exemplary embodiment or another exemplary embodiment may further include a step of outputting a data set to a file transfer protocol server, wherein the data set includes each conveyance reading of the set of conveyance readings and each geolocation associated with a respective conveyance reading of the set of conveyance readings. This exemplary embodiment or another exemplary embodiment may further include that the step of measuring for the conveyance that is carried inside of the utility further includes that the conveyance is one of gas, water, or electricity.

In another aspect, another exemplary embodiment of the present disclosure may provide a computer program product installed on a mobile device and including one or more non-transitory machine-readable mediums encoded with instructions that, when executed by one or more processors, cause a process to collect a set of conveyance readings along a surveyed utility. The instructions of the computer program product include: connect a utility detector to the computer program product via the mobile device; connect a global positioning system (GPS) unit to the computer program product via the mobile device; collect a set of conveyance readings from the utility detector in real time, wherein the conveyance is contained inside of the utility or escaped from the surveyed utility when measured by the utility detector; collect a set of geolocations from the GPS unit that correspond to the location of the set of conveyance readings in real-time; and output the set of conveyance readings and the set of geolocations to a processing program.

This exemplary embodiment or another exemplary embodiment may further include that the instruction to collect the set of conveyance readings from the utility detector in real time further includes that the each conveyance reading of the set of conveyance readings is collected at a predetermined time interval; and wherein the instruction to collect the set of geolocations from the GPS unit in real time further includes that the each geolocation of the set of geolocations is collected at the predetermined time interval. This exemplary embodiment or another exemplary embodiment may further include that the instruction to collect the set of conveyance readings from the utility detector in real time further includes that the each conveyance reading of the set of conveyance readings is collected at a predetermined time interval; and wherein the instruction to collect the set of geolocations from the GPS unit in real time further includes that the each geolocation of the set of geolocations is collected at the predetermined time interval. This exemplary embodiment or another exemplary embodiment may further include instructions to select a utility project; and save the measured conveyance readings and geolocations to the selected utility project. This exemplary embodiment or another exemplary embodiment may further include instructions to access application programming interface (API) from the mobile device; and access a database having a set of conveyance parameters related to the desired conveyance project. This exemplary embodiment or another exemplary embodiment may further include an instruction to record a profile of an inspector on the API from the mobile device that is operating the utility detector and the GPS unit. This exemplary embodiment or another exemplary embodiment may further include instructions to set the utility detector to a conveyance measurement threshold based on the selected utility project. This exemplary embodiment or another exemplary embodiment may further include an instruction to set time intervals of the collected conveyance readings based on the selected utility project. This exemplary embodiment or another exemplary embodiment may further include an instruction to output a data set to a file transfer protocol server, wherein the data set includes each conveyance reading of the set of conveyance readings and each geolocation associated with a respective conveyance reading of the set of conveyance readings. This exemplary embodiment or another exemplary embodiment may further include that the computer program product is agnostic to the utility detector and the GPS unit.

In yet another aspect, another exemplary embodiment of the present disclosure may provide a method of processing a set of collected conveyance readings of a utility. The method includes steps of: retrieving a set of conveyance readings from a database of a computer program product collected by a mobile device measured by a utility detector; retrieving a set of geolocations from the database of the computer program product collected by the mobile device measured by a global positioning system (GPS) unit, wherein each geolocation of the set of geolocations corresponds to a matching conveyance reading of the set of conveyance readings; matching each geolocation of the set of geolocations to a corresponding conveyance reading of the set of conveyance readings; and generating a set of breadcrumbs along a surveyed utility based on correlations between the set of conveyance readings and the set of geolocations.

This exemplary embodiment or another exemplary embodiment may further include a step of dividing the surveyed utility into a set of segmented utilities based on a predetermined length by the computer program product. This exemplary embodiment or another exemplary embodiment may further include steps of applying a spatial buffer around each segmented utility line of the set of segmented utilities; and determining a spatial location of at least one breadcrumb of the set of breadcrumbs relative to a boundary of the spatial buffer. This exemplary embodiment or another exemplary embodiment may further include a step of completing each segmented utility line of the set of segmented utilities when at least one breadcrumb is interior to the boundary of the spatial buffer. This exemplary embodiment or another exemplary embodiment may further include a step of maintaining each segmented utility line of the set of segmented utilities as incomplete when at least one breadcrumb is exterior to the boundary of the spatial buffer. This exemplary embodiment or another exemplary embodiment may further include that each incomplete segmented utility line is re-surveyed. This exemplary embodiment or another exemplary embodiment may further include a step of indicating each breadcrumb of the set of breadcrumbs with an identifier, by the computer program product, that is measured relative to a conveyance measurement threshold. This exemplary embodiment or another exemplary embodiment may further include that the step of indicating each breadcrumb of the set of breadcrumbs with the identifier measured further includes a safe identifier when the respective conveyance reading is less than the conveyance measurement threshold. This exemplary embodiment or another exemplary embodiment may further include that the step of indicating each breadcrumb of the set of breadcrumbs with the identifier measured further includes a danger identifier when the respective conveyance reading is greater than the conveyance measurement threshold. This exemplary embodiment or another exemplary embodiment may further include that the step of indicating each breadcrumb of the set of breadcrumbs with the identifier measured further includes an error identifier when the respective conveyance reading incurs an error. This exemplary embodiment or another exemplary embodiment may further include a step of outputting the set of breadcrumbs to an archive of the computer program product. This exemplary embodiment or another exemplary embodiment may further include steps of inputting known breadcrumbs of a known set of breadcrumbs; and correlating the known set of breadcrumbs with the set of breadcrumbs to generate a second report.

In yet another aspect, another exemplary embodiment of the present disclosure may provide a computer program product including one or more non-transitory machine-readable mediums encoded with instructions that, when executed by one or more processors, cause a process to generate a set of breadcrumbs along a surveyed utility line. The instructions of the computer program product includes: retrieve the set of conveyance readings from a database of the computer program product collected by a mobile device measured by a utility detector; retrieve a set of geolocations from the database of the computer program product collected by the mobile device measured by a global positioning system (GPS) unit, wherein each geolocation of the set of geolocations corresponds to a matching conveyance reading of the set of conveyance readings; match each geolocation of the set of geolocations to a corresponding conveyance reading of the set of conveyance readings; and generate the set of breadcrumbs along the surveyed utility line based on correlations between the set of conveyance readings and the set of geolocations.

This exemplary embodiment or another exemplary embodiment may further include an instruction to indicate each breadcrumb of the set of breadcrumbs with an identifier, by the computer program product, that is measured relative to a conveyance measurement threshold. This exemplary embodiment or another exemplary embodiment may further include that the instruction to indicate each breadcrumb of the set of breadcrumbs with the identifier measured further includes a safe identifier when the respective conveyance reading is less than the conveyance measurement threshold. This exemplary embodiment or another exemplary embodiment may further include that the instruction to indicate each breadcrumb of the set of breadcrumbs with the identifier measured further includes a danger identifier when the respective conveyance reading is greater than the conveyance measurement threshold. This exemplary embodiment or another exemplary embodiment may further include an instruction to divide the surveyed utility line into a set of segmented utilities based on a predetermined length by the computer program product. This exemplary embodiment or another exemplary embodiment may further include instructions to apply a spatial buffer around each segmented utility line of the set of segmented utilities; and determine a spatial location of at least one breadcrumb of the set of breadcrumbs relative to a boundary of the spatial buffer. This exemplary embodiment or another exemplary embodiment may further include an instruction to complete each segmented utility line of the set of segmented utilities when at least one breadcrumb is interior to the boundary of the spatial buffer. This exemplary embodiment or another exemplary embodiment may further include an instruction to maintain each segmented utility line of the set of segmented utilities as incomplete when at least one breadcrumb is exterior to the boundary of the spatial buffer; wherein each incomplete segmented utility line is re-surveyed.

In yet another aspect, another exemplary embodiment of the present disclosure may provide a method of searching a set of collected conveyance readings of a utility. The method includes steps of: retrieving at least one generated map from a generated maps server; retrieving a set of breadcrumbs from a processed files server; accessing a querying server that provides a set of conveyance parameters; inputting at least one conveyance parameter into the set of conveyance parameters of the querying server; and outputting one or more breadcrumbs of the set of breadcrumbs based on the at least one conveyance parameter inputted into the querying server.

This exemplary embodiment or another exemplary embodiment may further include that the step of inputting the at least one conveyance parameter into the set of conveyance parameters of the querying server further comprises: inputting a first conveyance measurement threshold into the querying server that relates to a primary conveyance measurement threshold stored in a computer program product; and inputting a second conveyance measurement threshold into the querying server that relates to the primary conveyance measurement threshold stored in the computer program product; wherein the second conveyance measurement threshold is greater than the first conveyance measurement threshold. This exemplary embodiment or another exemplary embodiment may further include that the first conveyance measurement threshold input into the querying server is less than the primary conveyance measurement threshold. This exemplary embodiment or another exemplary embodiment may further include that the first conveyance measurement threshold input into the querying server is equal to or greater than the primary conveyance measurement threshold. This exemplary embodiment or another exemplary embodiment may further include a step of updating at least one breadcrumb with corrected information by an update server of the computer program product when the at least one breadcrumb includes an error. This exemplary embodiment or another exemplary embodiment may further include a step of updating the at least one segmented utility line with corrected information by a manual update tool of the computer program product. This exemplary embodiment or another exemplary embodiment may further include that the step of updating the at least one segmented utility line with the corrected information further includes: inputting whether the at least one segmented utility line is complete or un-complete; and selecting a manual update reason from a plurality of manual update reasons when the at least one segmented utility line is complete. This exemplary embodiment or another exemplary embodiment may further include that the step of inputting the at least one conveyance parameter into the set of conveyance parameters of the querying server further comprises: inputting a name of an inspector or a reference area.

In yet another aspect, another exemplary embodiment of the present disclosure may provide a computer program product installed on a mobile device and including one or more non-transitory machine-readable mediums encoded with instructions that, when executed by one or more processors, cause a process to search a set of collected conveyance readings of a surveyed utility line. The instructions of the computer program product include retrieve at least one generated map from a generated maps server; retrieve a set of breadcrumbs from a processed files server; access a querying server that provides a set of conveyance parameters; input at least one conveyance parameter into the set of conveyance parameters of the querying server; and output one or more breadcrumbs of the set of breadcrumbs based on the at least one conveyance parameter inputted into the querying server.

This exemplary embodiment or another exemplary embodiment may further include that the instruction to input the at least one conveyance parameter into the set of conveyance parameters of the querying server further comprises: input a first conveyance measurement threshold into the querying server that relates to a primary conveyance measurement threshold stored in the computer program product; and input a second conveyance measurement threshold into the querying server that relates to the primary conveyance measurement threshold stored in the computer program product; wherein the second conveyance measurement threshold is greater than the first conveyance measurement threshold. This exemplary embodiment or another exemplary embodiment may further include that the first conveyance measurement threshold input into the querying server is less than the primary conveyance measurement threshold. This exemplary embodiment or another exemplary embodiment may further include that the first conveyance measurement threshold input into the querying server is equal to or greater than the primary conveyance measurement threshold. This exemplary embodiment or another exemplary embodiment may further include an instruction to update at least one breadcrumb with corrected information by an update server of the computer program product when the at least one breadcrumb includes an error. This exemplary embodiment or another exemplary embodiment may further include an instruction to update the at least one segmented utility line with corrected information by a manual update tool of the computer program product. This exemplary embodiment or another exemplary embodiment may further include that the instruction to update the at least one segmented utility line with the corrected information further includes: input whether the at least one segmented utility line is complete or un-complete; and select a manual update reason from a plurality of manual update reason when the at least one segmented utility line is complete. This exemplary embodiment or another exemplary embodiment may further include that the instruction to input the at least one conveyance parameter into the set of conveyance parameters of the querying server further comprises: input a name of an inspector or a reference area.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1A is a diagrammatic view of an inspector surveying a utility line with an inspection system, wherein the inspection system includes an inspection protocol.

FIG. 1B is another diagrammatic view continuing from FIG. 1A, wherein the inspector begin to survey the utility line with the inspection system at a starting point.

FIG. 1C is another diagrammatic view continuing from FIG. 1B, wherein the inspection system measures and records a first conveyance reading and a first geolocation along the utility line that correlates to a first breadcrumb.

FIG. 1D is another diagrammatic view continuing from FIG. 1C, wherein the inspection system measures and records a second conveyance reading and a second geolocation along the utility line that correlates to a second breadcrumb.

FIG. 1E is another diagrammatic view continuing from FIG. 1D, wherein the inspection system measures and records a third conveyance reading and a third geolocation along the utility line that correlates to a third breadcrumb.

FIG. 2 is a block diagram of a collecting program of the inspection protocol.

FIG. 3 is a block diagram of the collecting program, wherein a set of utility segments and a set of breadcrumbs are generated by the processing program.

FIG. 4 is a flowchart of the processing program shown in FIG. 3.

FIG. 5 is a block diagram of a querying program of the inspection protocol in communication with the processing program.

FIG. 6A is a diagrammatic view of a querying interface included with querying program for selecting one or more specific breadcrumbs.

FIG. 6B is a diagrammatic view of another querying interface included with querying program for updating pipeline segments.

FIG. 7A is a diagrammatic view of an inspector surveying a utility line with the inspection system inside one of the surveyed areas shown in the plot in FIG. 7A, wherein each breadcrumb is assigned a first utility indicator.

FIG. 7B is another diagrammatic view continuing from FIG. 7A, wherein the inspector surveys and records another breadcrumb that is assigned a second utility indicator where a leak is uncovered.

FIG. 7C is another diagrammatic view continuing from FIG. 7B, wherein the inspector surveys and records another breadcrumb that is assigned a third utility indicator.

FIG. 7D is a diagrammatic view of a set of pipeline segments and a set of breadcrumbs that are generated by the processing program subsequent to surveying the utility line in FIG. 7B.

FIG. 7E is another diagrammatic view continuing from FIG. 7E, wherein a spatial buffer is generated around each pipeline segment of the set of pipeline segments.

FIG. 7F is another diagrammatic view continuing from FIG. 7F, wherein one or more breadcrumbs are validated or invalided by the processing program.

FIG. 8 is a diagrammatic view of an area surveyed by the inspection system, wherein at least one conveyance line is validated and at least one conveyance is invalidated.

FIG. 9 is another diagrammatic view continuing from FIG. 8, wherein at least three utilities are validated and include one or more validated breadcrumbs.

FIG. 10 is a flowchart of an exemplary method of collecting a set of conveyance readings along a utility line.

FIG. 11 is a flowchart of an exemplary method of processing a set of collected conveyance readings of a utility.

FIG. 12 is a flowchart of an exemplary method of searching a set of collected conveyance readings of a utility.

Similar numbers refer to similar parts throughout the drawings.

### DETAILED DESCRIPTION

It should be understood that the term “breadcrumb” used herein may be generally defined as a temporally data point containing, at a minimum, a latitude coordinate measured by a surveying device or unit at a collected position or location, a longitude coordinate measured by a surveying device or unit at the collected position or location, and a time stamp or reference at which the creation of the record occurred. As such, each “breadcrumb” is a temporally data point of a particular measured conveyance includes all three components or parameters when a breadcrumb is mentioned and discussed herein. It should also be understood that the term “breadcrumbs” or “set of breadcrumbs” used herein may be generally defined as a temporally sequential series of data points containing, at a minimum, latitude coordinates measured by a surveying device or unit at collected positions or locations, longitude coordinates measured by a surveying device or unit at the collected positions or locations, and time stamps or references at which the creation of the records occurred.

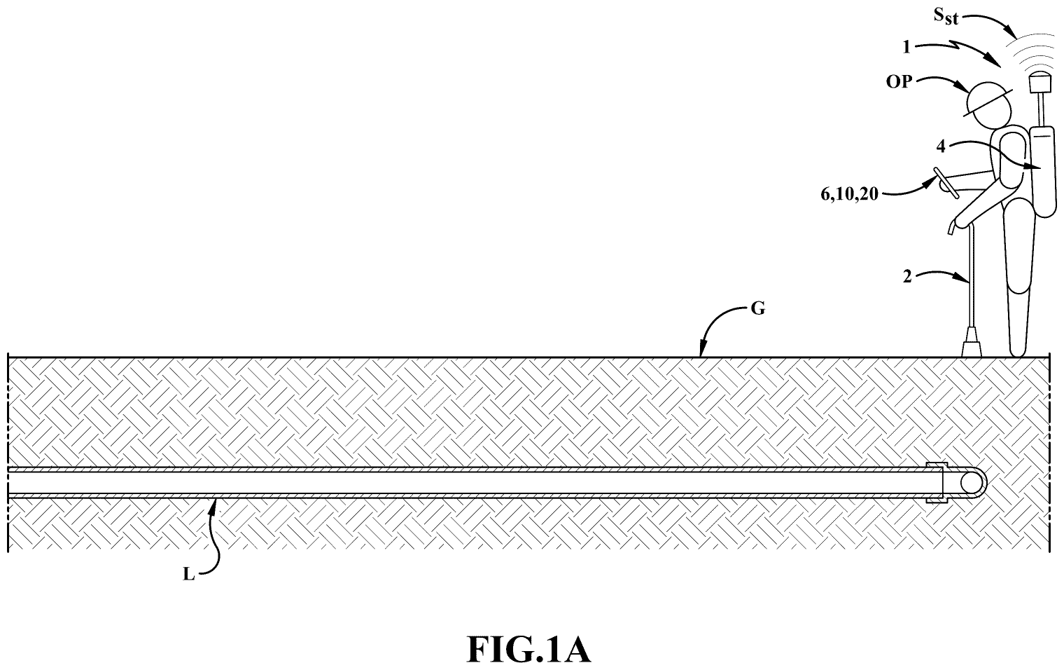

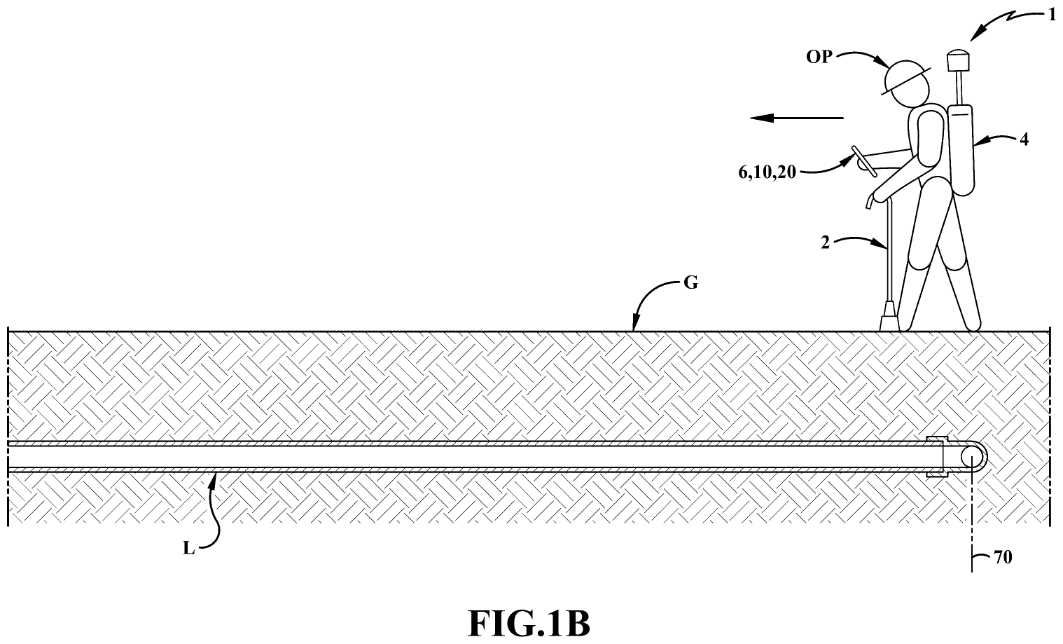

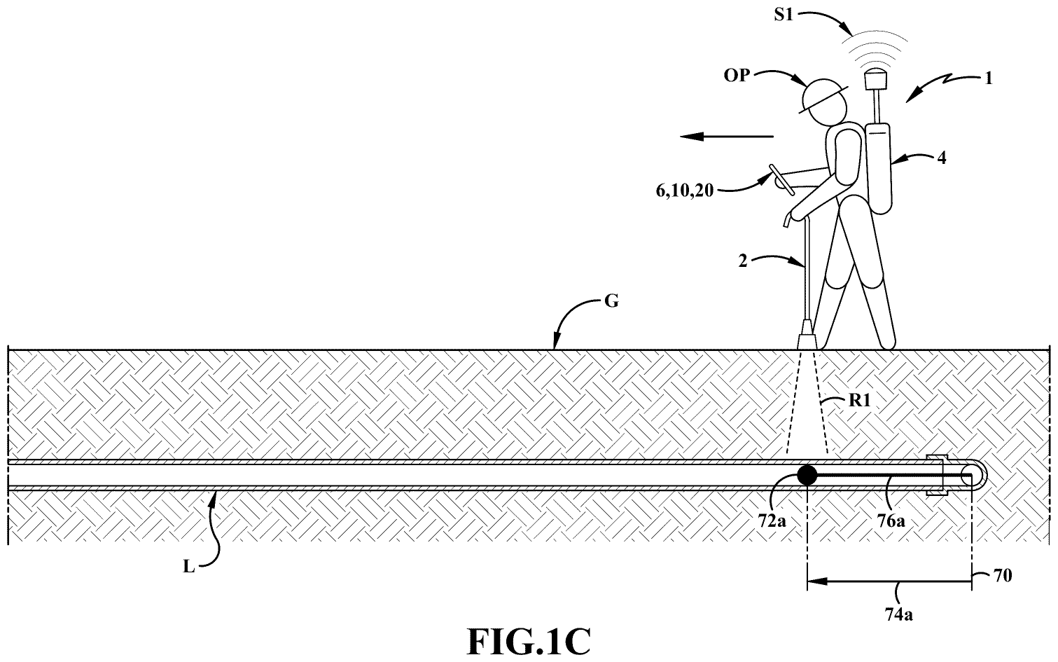

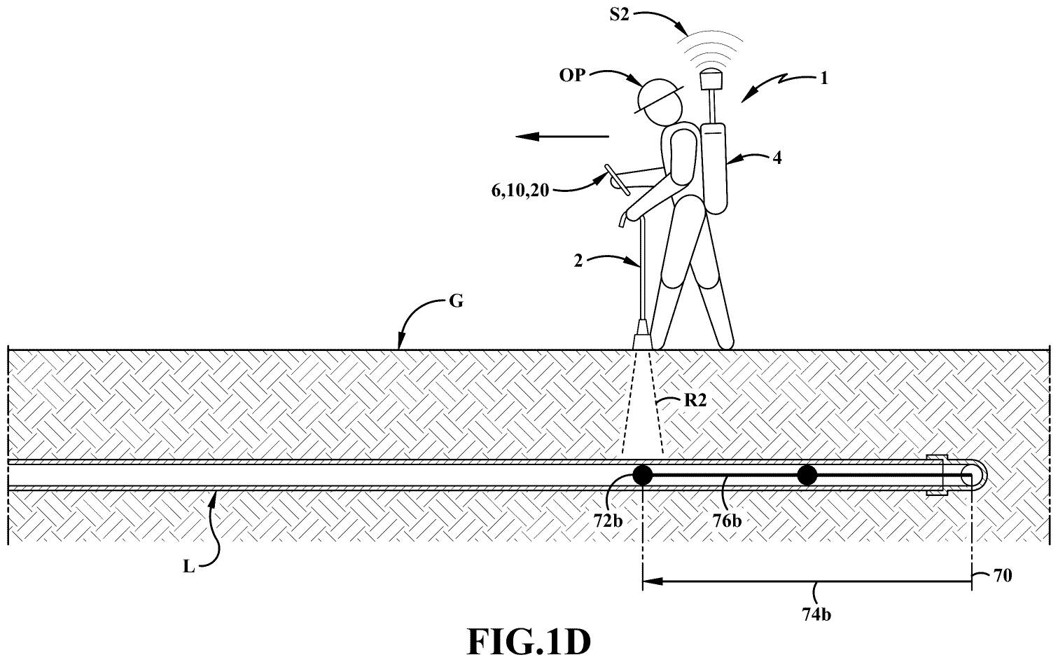

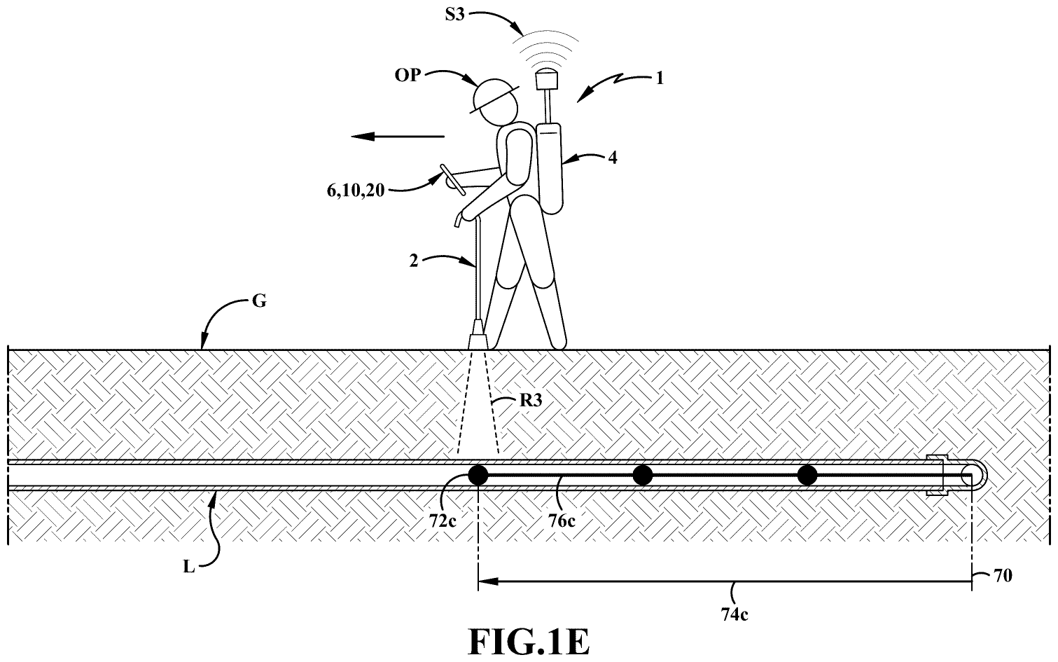

FIGS. 1A-1E illustrate an inspection kit or system, which is generally referred to as 1, that is being carried and operated by an inspector or surveyor (labeled “OP” herein). As discussed in greater detail below, the inspection system 1 is configured to survey and inspect a desired conveyance carried or conveyed by a utility that includes appropriate devices or tools for measuring and inspecting the desired conveyance while automatically collecting and generating tangible reports based on the conveyance measurements by a computer program product installed into inspection kit 1.

As best seen in FIGS. 1A-1E, inspection system 1 includes a utility detector 2 and a global positioning system (hereinafter GPS) unit 4 that are operable to communicate with a mobile computing device 6. In the present disclosure, utility detector 2 is configured to sense and measure the presence of a desired conveyance in an area when the utility detector 2 traverses over utilities or utility pipelines that carry or convey the desired conveyance; as such, the utility detector 2 measures and outputs a conveyance reading or measurement at a predetermined time interval or predetermined location. Additionally, GPS unit 4 is configured to locate and measure a geolocation of each conveyance reading or measurement taken by the utility detector 2 when traversing over utilities or utility pipelines that carry the desired conveyance. Further, mobile device 6 is configured to receive each conveyance reading from the detector 2 as well as each geolocation of a respective conveyance reading from the GPS unit 4. As discussed in greater detail below, mobile device 6 is configured to output the conveyance readings and geolocations to a computer program product of the inspection system 1 to generate a set of breadcrumbs that are included on a tangible report to view one or more breadcrumbs in a given inspected area.

In the present disclosure, the utility detector 2 of inspection system 1 is a gas detector or tool that is configured to detect and/or sense the presence of gas in an area when the gas detector traverses over a gas line or a gas pipeline that carries said gas. In this embodiment, gas detector is primarily used for detecting the presence of natural gas in residential, commercial, and/or industrial areas that have buried or concealed gas lines or gas pipelines. It should be understood that inspection system 1 may include any suitable detector (commercially available or non-commercially available at the time of filing the respective disclosure) for measuring any suitable utility found in residential, commercial, and/or industrial areas. In one example, a utility detector of inspection system discussed herein may be a water or wastewater detector or tool that is configured to detect and/or sense the presence of water in an area when the water detector traverses over a water line or a water pipeline that carries said water. In another example, a utility detector 2 inspection system 1 discussed herein may be an electricity detector or tool that is configured to detect and/or sense the presence of electricity in an area when the electricity detector traverses over an electrical line that carries said electricity.

In the present disclosure, GPS unit 4 is configured to locate and measure a geolocation of each conveyance reading or measurement taken by the utility detector 2 when traversing over utilities or utility pipelines that carry the desired conveyance. Here, GPS unit 4 is a mobile GPS unit that is commercially available at the time of filing this disclosure for tracking and plotting geolocation of each conveyance reading or measurement taken by utility detector when traversing over utilities or utility pipelines that carry the desired conveyance. It should be understood that any suitable GPS unit or similar geolocating unit may be used for tracking and plotting geolocation of each conveyance reading or measurement taken by utility detector when traversing over utilities or utility pipelines that carry the desired conveyance.

In the present disclosure, mobile device 6 is shown as a mobile cellular device or smartphone being held by surveyor in which the utility detector 2 and the GPS unit 4 are operable to connect with the mobile device 6 through commercially-available communication protocols or applications. It should be understood that mobile device discussed herein may be any suitable mobile device (commercially available or non-commercially available at the time of filing the disclosure) that may be operable to communicate with a utility detector and a GPS unit discussed herein. Examples of suitable mobile devices that may be used in inspection system 1 includes tablets, personal computers, and other similar mobile devices that may be capable of communicating with a utility detector and a GPS unit discussed herein.

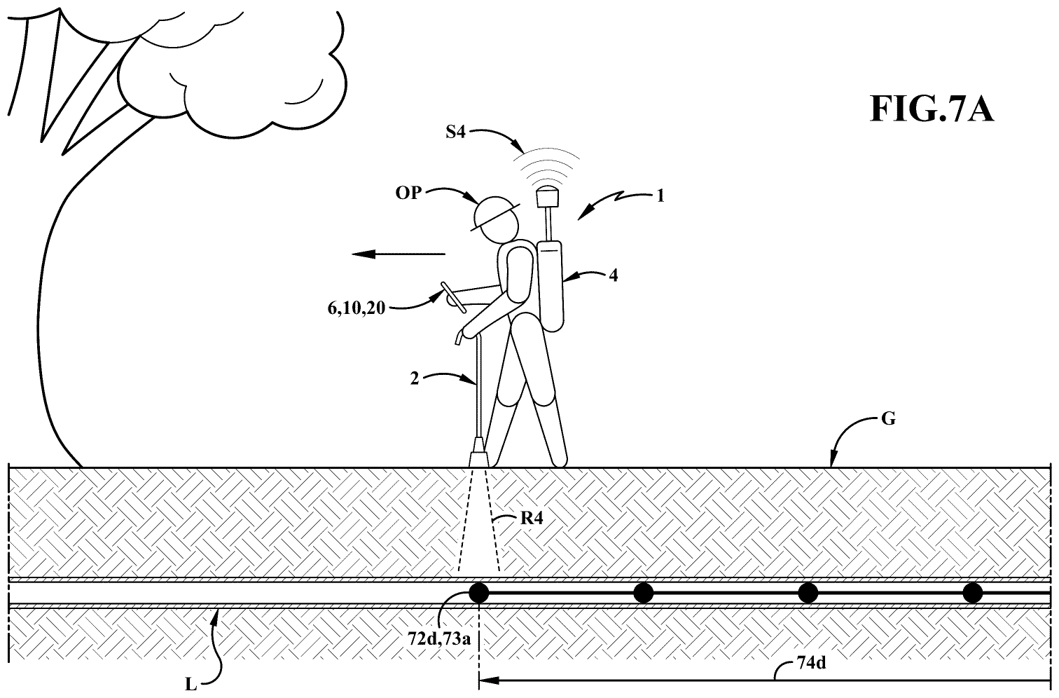

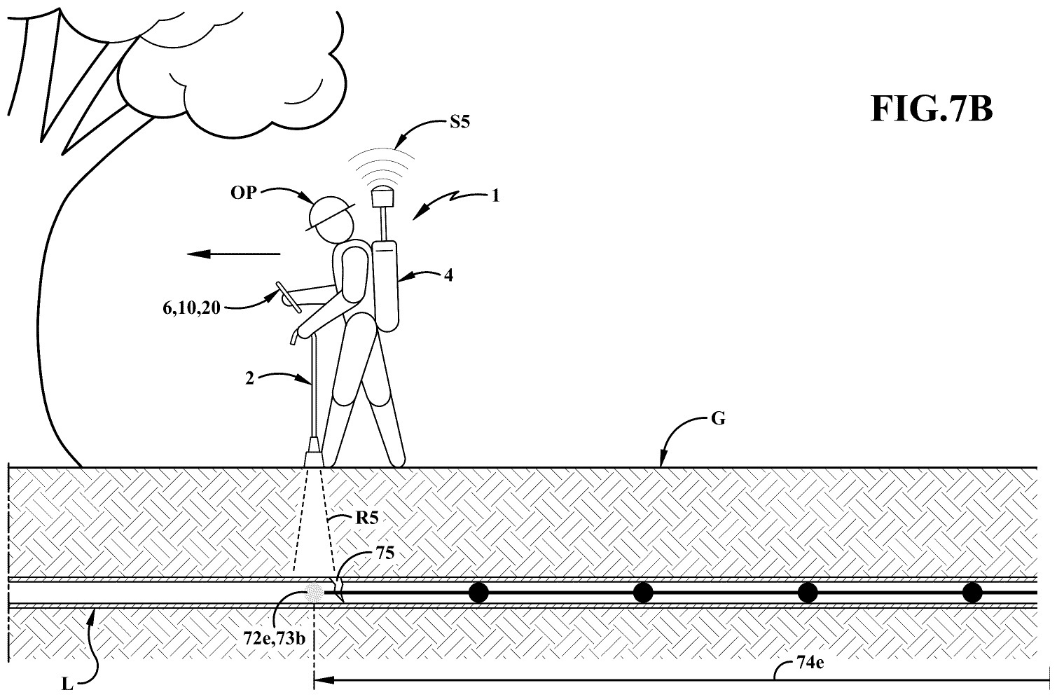

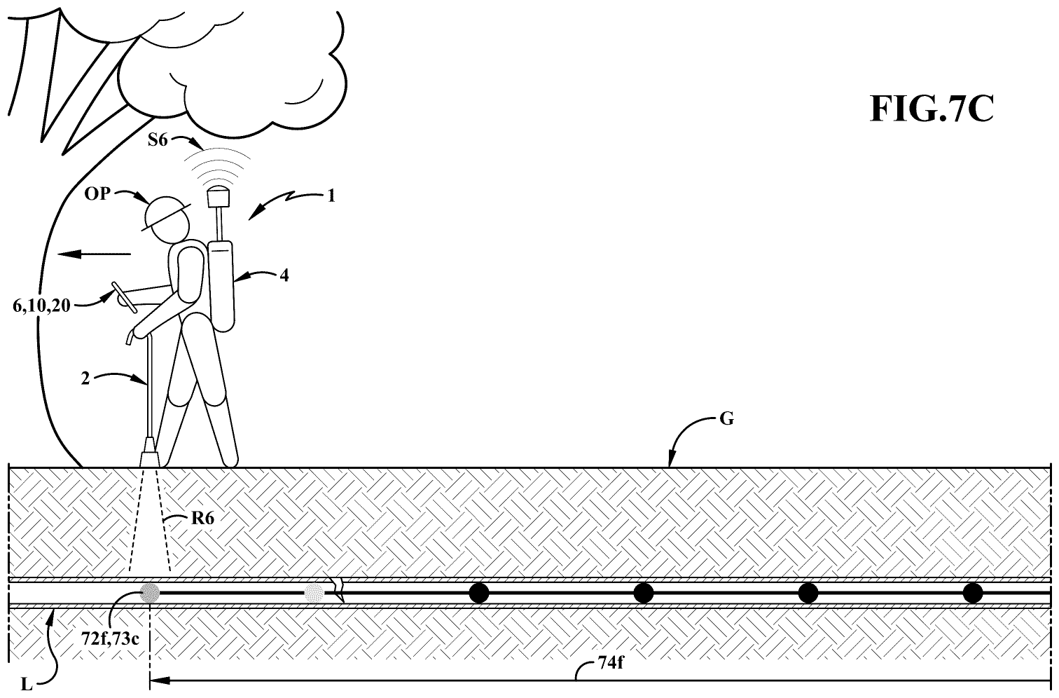

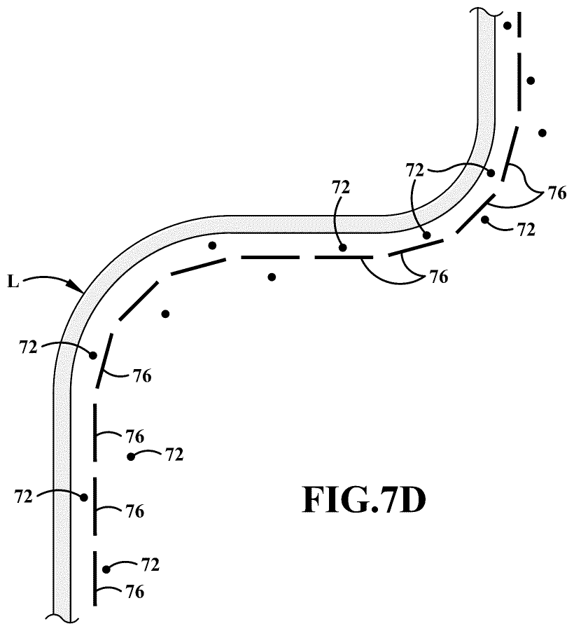

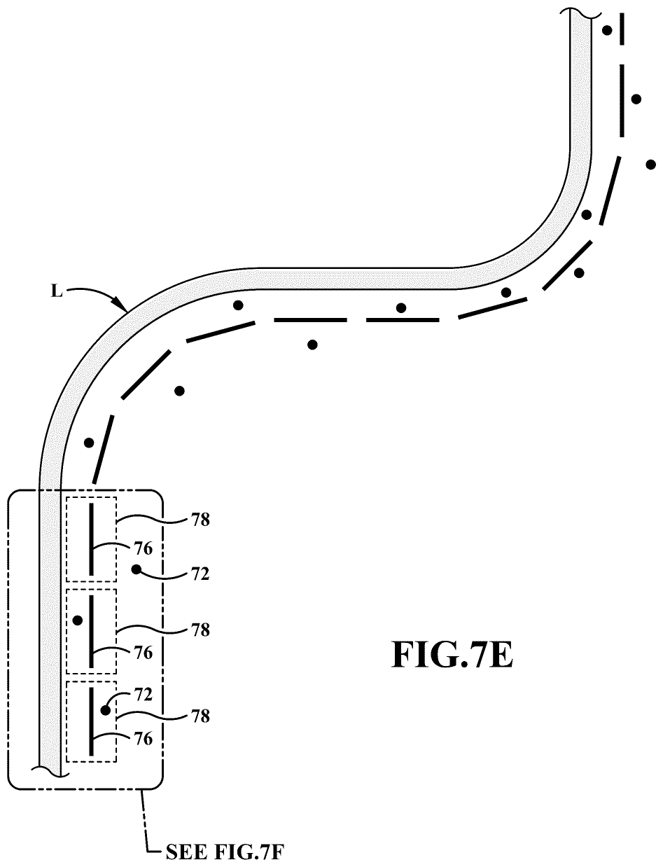

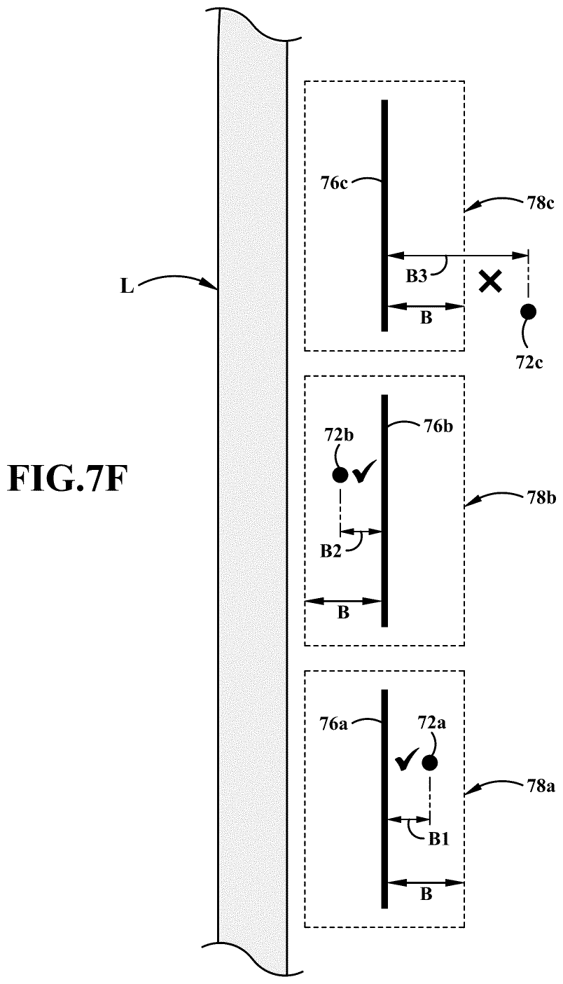

As mentioned briefly above, inspection system 1 also includes a computer program product or inspection protocol 10. In the present disclosure, inspection protocol 10 is installed one or more devices (such as mobile device 6) in order for the surveyor to connect the utility detector 2 and the GPS unit 4 to send conveyance readings and geolocation to the inspection protocol 10 in real time via the mobile device 6. As discussed in greater detail below, the inspection protocol 10 includes three programs that are used during the inspection or collecting stage shown in FIGS. 1A-1E and FIGS. 7B-7D, during the processing stage performed subsequent to the inspection stage and as shown in FIGS. 7E-9, and during the querying stages performed subsequent to the inspection and process stages. Such programs of the inspection protocol 10 are now discussed in greater detail below.

Inspection protocol 10 includes a collecting program 20 that is executed during the surveying or collecting stages of one or more utilities or utility pipelines. The collecting program 20 is the initial program that is executed by inspection system 1 to collect conveyance readings and geolocations of said conveyance readings for one or more utilities. Such functions and blocks of collecting program 20 are now discussed in greater detail below.

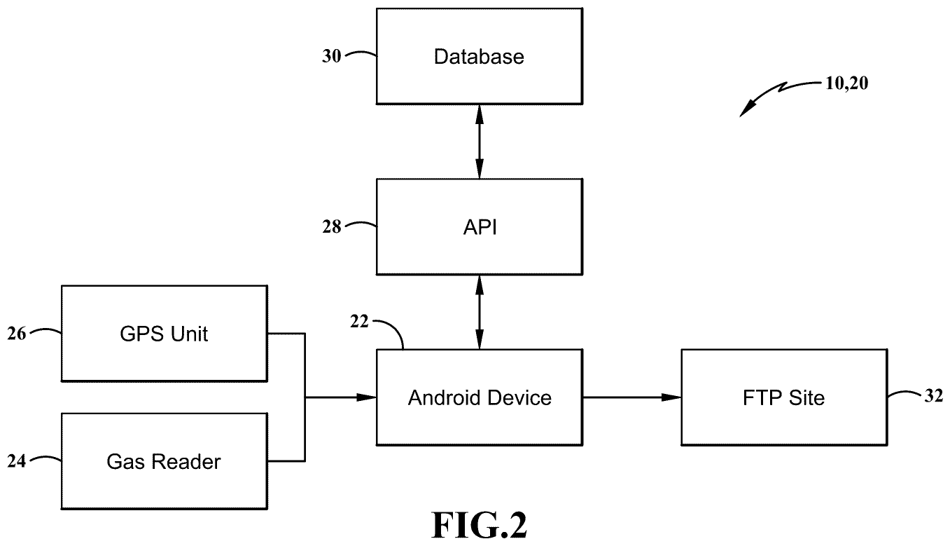

In the present disclosure, collecting program 20 includes a mobile device block 22 that symbolizes the mobile device 6 in collecting program 20. The mobile device block 22 is diagrammatically shown as a box labeled 22 in FIG. 2. In operation, mobile device block 22 is configured to receive surveyed data from one or more blocks as well as output surveyed data to one or more blocks included in the collecting program 20 for processing.

Still referring to collecting program 20, collecting program 20 also includes a utility detector block 24 (diagrammatically shown by a box in FIG. 2) that symbolizes the utility detector 2 in collecting program 20. Similarly, collecting program 20 also includes a GPS unit block 26 (diagrammatically shown by a box in FIG. 2) that symbolizes the GPS unit 4 in collecting program 20. As discussed previously, utility detector block 24 is operatively in communication with the mobile device block 22 in which the utility detector block 24 outputs conveyance readings of the measured conveyance to the mobile device block 22; such one-way communication is denoted by an arrow pointing from the utility detector block 24 to the mobile device block 22. As discussed previously, GPS unit block 26 is also operatively in communication with the mobile device block 22 in which the GPS unit block 26 outputs geolocations of each measured conveyance reading to the mobile device block 22; such one-way communication is denoted by an arrow pointing from the GPS unit block 26 to the mobile device block 22.

Collecting program 20 also includes an application program interface (API) 28. As best seen in FIG. 2, API block 28 is diagrammatically shown as a box labeled 28 that is operatively in communication with the mobile device block 22. In operation, API 28 is configured to receive conveyance readings and geolocations from the mobile device block 22 that were measured by the utility detector 2 (via utility detector block 24) and by the GPS unit 4 (via GPS unit block 26). Additionally, API 28 is also configured to transmit device data and device settings to the mobile device block 22 for setting the utility detector 2 and the GPS unit 4 to a predetermined set of parameters toggled by the surveyed when selecting a given survey or utility project, which are discussed in greater detail below. As such, the two-way communication between the mobile device block 22 and the API 28 is denoted by double arrows pointing to the mobile device block 22 and to the API 28.

Collecting program 20 also includes a database 30. As best seen in FIG. 2, database 30 is diagrammatically shown as a box labeled 30 herein and is operatively in communication with API 28. In operation, database 30 may be installed or loaded with a plurality of inspection parameters or calibrations settings that may be accessed from the mobile device 6, through mobile device block 22 and API 28, when the surveyor of inspection system 1 is calibrating the utility detector 2 and the GPS unit 4 for a given survey project. With this configuration, the two-way communication between the API 28 and database 30 is denoted by double arrows pointing to the API 28 and the database 30. It should be understood that such calibration parameters may be based on various considerations, including preferences set by a customer, state or federal guidelines, etc.

It should be understood that database 30 may be installed or loaded with any suitable inspection parameters or measurement parameters that may be accessed by the surveyor when said surveyor is setting up the utility detector 2 and the GPS unit 4 for a given survey project. In one example, database 30 may be installed or loaded with a variety of parameters or calibration settings for one or more types of utility detectors based on the conveyance that is carried or conveyed by a utility that is intended to be surveyed or measured during a given survey project. In another example, database 30 may installed or loaded with a variety of parameters or calibration settings for one or more types of GPS units that may be used along with a given utility detectors. It yet another example, such parameters or calibration settings may also include time periods or time intervals at which the utility detector may measure and output a conveyance reading; such time intervals may be within a range from about 1 second up to about 5 seconds. In this same example, calibration settings may also include time periods or time intervals at which the GPS unit may measure and output a geolocation based on the conveyance readings; such time intervals for the utility detector and the GPS unit align with one another so that conveyance readings and geolocations are measured and recorded simultaneously with one another.

Still referring to FIG. 2, collecting program 20 also includes a file transfer protocol (FTP) site or server 32. In the present disclosure, FTP site 32 is diagrammatically shown as a box labeled 32 herein and is operatively in communication with the mobile device block 22 to receive data from the mobile device block 22; such one-way communication is denoted by an arrow pointing from the mobile device block 22 to the FTP site 32. In operation, FTP site 32 is configured to receive the conveyance readings, measured by utility detector 2, and geolocation of the conveyance readings, measured by the GPS unit 4, for further processing that is performed by a processing server included in the inspection protocol, which is discussed in greater detail below.

Inspection protocol 10 includes a processing program 40 that is executed subsequent to the collecting program 20 upon one or more utilities or utility pipelines being surveyed. In the present disclosure, processing program 40 is configured to gather and generate a tangible medium or report that shows a set of breadcrumbs for one or more inspected utilities upon accessing conveyance readings and geolocations collected in the collecting program 20. Processing program 40 is also configured to generate a set of segmented utilities for each utility or utility pipeline surveyed. Processing program 40 is also configured to validate one or more segmented utilities of a set of segmented utilities based on a spatial distance measured between the segmented utility and the breadcrumbs where said breadcrumbs are near or proximate to the respective segmented utility. Such functions and blocks of the processing program 40 are discussed in greater detail below.

As discussed above, the processing program 40 is executed subsequent to the collecting program 20 upon one or more utilities or utility pipelines being surveyed. In the present disclosure, processing program 40 may be accessed and executed by one or more processors or computing units subsequent to survey projects. In one example, processing program 40 may be accessed and executed by one or more processors or computing units remote from the surveyed area. In another example, processing program 40 may be accessed and executed by one or more processors or computing units near or at the surveyed area (e.g., mobile device 6).

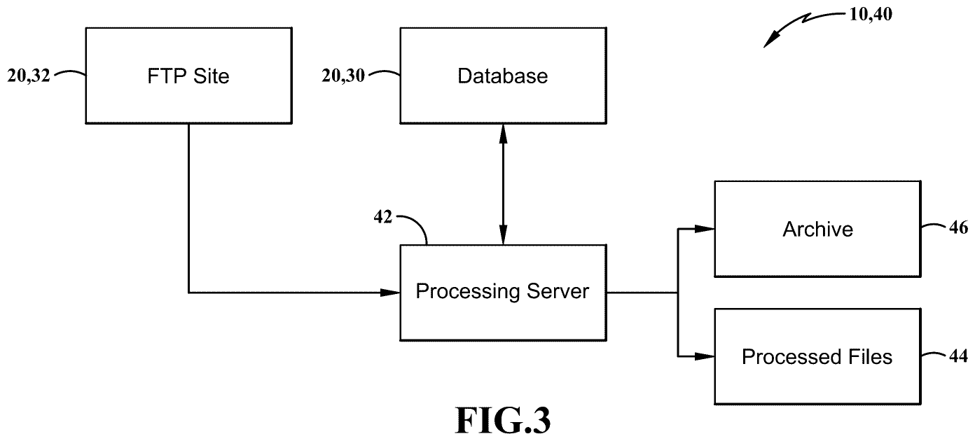

In the present disclosure, processing program 40 includes a processing server 42. As best seen in FIG. 3, processing server 42 is diagrammatically shown as a box labeled 42 that is operatively in communication with the collecting program 20 and one or more servers of the processing program 40, which are discussed in greater detail below. Particularly, processing server 42 is operatively in communication with the database 30 of the collecting program 20 to access and acquire data and information from the database 30 that is relevant to a given survey project for generating a set of breadcrumbs and a set of segmented utilities for each surveyed utility discussed in greater detail below. Such two-way communication is denoted by a double arrow pointing at the database 30 and at the processing server 42 in FIG. 3. Further, processing server 42 is operatively in communication with the FTP site 32 of the collecting program 20 to receive the conveyance readings and geolocations collected in the collecting program 20; such one-way communication is denoted by a single arrow pointing from the FTP site 32 to the processing server 42 in FIG. 3.

Still referring to the processing program 40, processing program 40 also includes a processed files server 44. As best seen in FIG. 3, processed files server 44 is diagrammatically shown as a box labeled 44 and is operatively in communication with the processing server 42. In operation, processed files server 44 receives processed data and information from processing server 42 that is generated by said processing server 42, including at least one set of breadcrumbs, one or more segmented utilities, and other relevant survey information discussed in greater detail below. Such one-way communication is denoted by a single arrow pointing from the processing server 42 to the processed files server 44 in FIG. 3.

Still referring to the processing program 40, processing program 40 also includes an archive server 46. As best seen in FIG. 3, archive server 46 is diagrammatically shown as a box labeled 46 and is operatively in communication with the processing server 42. In operation, archive server 46 receives processed data and information from processing server 42 that is generated by said processing server 42, including at least one set of breadcrumbs, one or more segmented utilities, and other relevant survey information; such one-way communication is denoted by a single arrow pointing from the processing server 42 to the processed files server 44 in FIG. 3. It should be understood that such processed data and information transmitted from the processing server 42 to the archive server 46 may be recalled and used in future survey projects if desired by a customer or user to compare previous surveyed information with new and/or updated surveyed information collected in subsequent survey projects.

It should be understood that such execution of the processing program 40 may occur subsequent to the collecting program 20 and remote from the surveyed area. Stated differently, the execution of the processing program 40 may occur offsite at a location that is away from the surveyed area once the conveyance readings and the geolocations of the conveyance readings are collected in the collecting program 20. In one exemplary embodiment, the execution of the processing program 40 may occur concurrently or simultaneously with the collecting program 20 once the processing program 40 accesses and/or receives conveyance readings and geolocations collected in the collecting program 20. In another exemplary embodiment, the execution of the processing program 40 may occur concurrently or simultaneously with the collecting program 20 on the mobile device 6 once the processing program 40 accesses and/or receives conveyance readings and geolocations collected in the collecting program 20.

Inspection protocol 10 includes a querying program 60 that is executed subsequent to the collecting program 20 and subsequent to the processing program 40. In the present disclosure, querying program 60 is configured to allow a user to request and search for one or more breadcrumbs processed by the processing program 40 or a surveyed utility processed by the processing program 40. Querying program 60 is also configured to allow a user to manually update one or more segmented utilities that were not surveyed or incurred errors related to the survey (e.g., error when measuring and collecting utility in the field, error when measuring and collecting the geolocation in the field, etc.). Such functions and blocks of the querying program 60 are discussed in greater detail below.

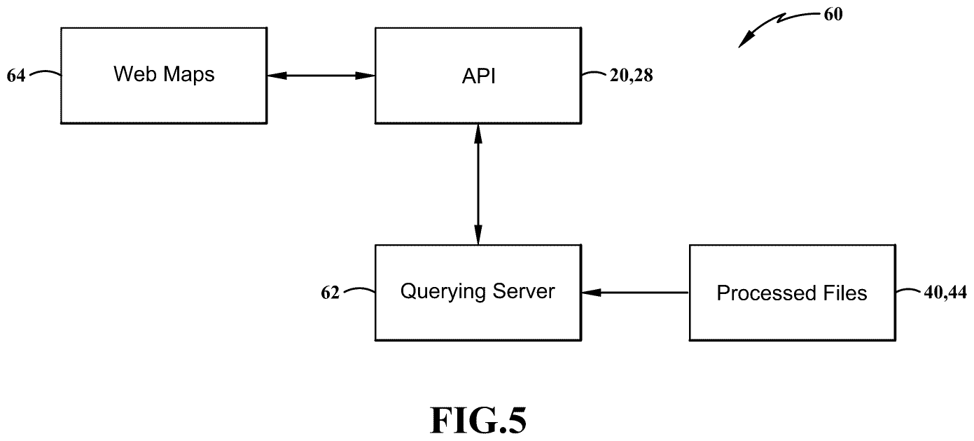

In the present disclosure, querying program 60 includes a querying server 62. As best seen in FIG. 5, querying server 62 is diagrammatically shown as a box labeled 62 that is operatively in communication with the collecting program 20 and the processing program 40. Particularly, querying server 62 is operatively in communication with the API 28 of the collecting program 20 to access and acquire data and information from the database 30 that is relevant to a given survey project for generating a set of breadcrumbs; such two-way communication is denoted by a double arrow pointing at the API 28 and at the processing server 42 in FIG. 5. Further, querying server 62 is operatively in communication with the processed files server 44 of the processing program 40 to receive the set of breadcrumbs and segmented utilities generated by the processing program 40; such one-way communication is denoted by a single arrow pointing from the processed files server 44 to the querying server 62 in FIG. 5.

Still referring to querying program 60, querying program 60 also includes a web maps server 64. As best seen in FIG. 5, web maps server 64 is diagrammatically shown as a box labeled 64 that is operatively in communication with the collecting program 20. Particularly, web maps server 64 is operatively in communication with the API 28 of the collecting program 20 to access and acquire data and information from the database 30 that is relevant to a given survey project for generating a set of breadcrumbs; such two-way communication is denoted by a double arrow pointing at the API 28 and at the web maps server 64 in FIG. 5.

In operation, querying server 62 may have access to information collected in the collecting program 20, via the API 28, access to one or more breadcrumbs and one or more segmented utilities generated by the processing program 40, and access to web-based maps from the web maps server 64 in order to view the one or more breadcrumbs and one or more segmented utilities in a selected area that may be located on said web-based maps.

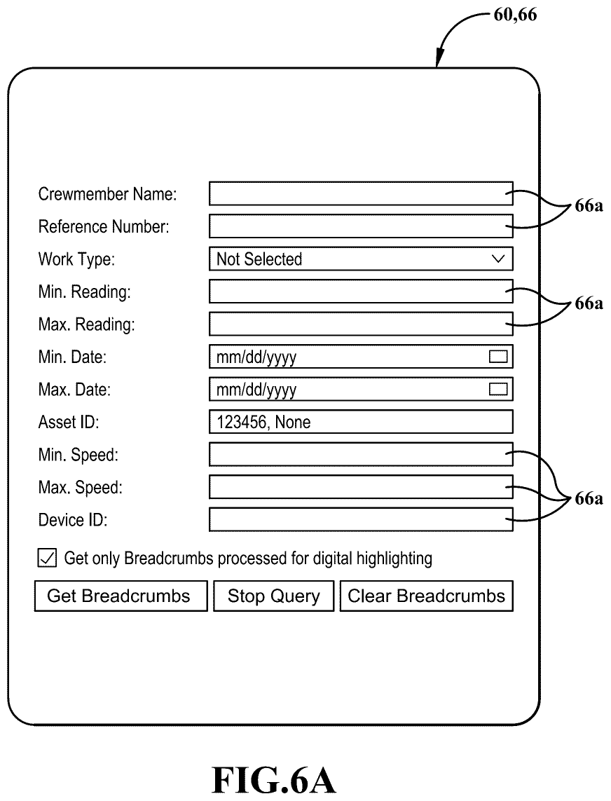

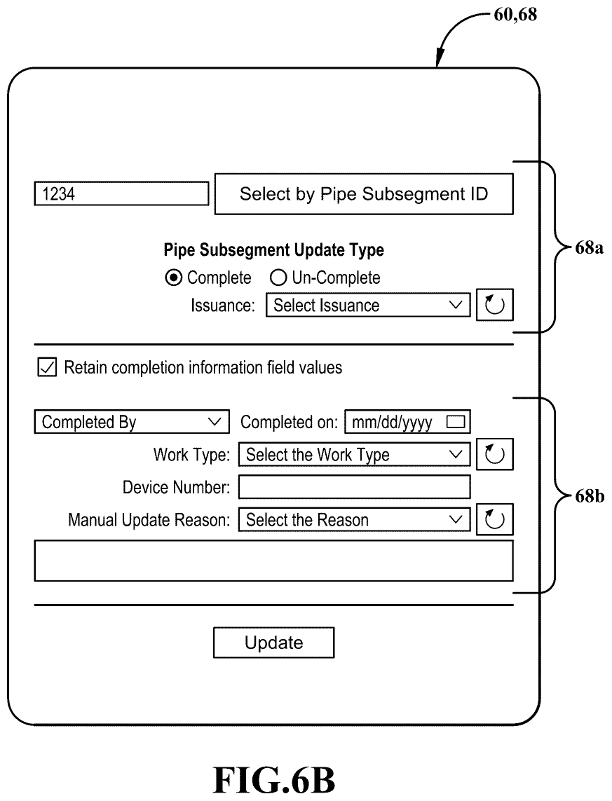

Still referring to querying program 60, the querying server 62 may be accessible to a user through one or more interfaces. In one example, and as best seen in FIG. 6A, querying program 60 includes a query interface 66 that provides access to the querying server 62 for finding one or more breadcrumbs of a given survey project. In this example, the query interface 66 offers a set of query parameters 66a to find and view one or more breadcrumbs generated from a given survey project. The parameters of the set of query parameters 66a may include, but are not limited to, names of crewmembers or surveyors, a reference number relating to each surveying project, type of work, the minimum and maximum measurement readings for a surveyed utility, dates of the surveying project, the minimum and maximum speeds of reading a surveyed utility, and identification of devices used during the surveyed project. It should be understood that such parameters are also included in the collecting program 20 and the processing program 40 in order to match and correlate similar information and data collected and generated by inspection protocol 10.

In another example, and as best seen in FIG. 6B, querying program 60 includes an update interface 68 that provides access to the querying server 62 for updating one or more segmented utilities of a given survey project. In this example, the update interface 68 offers a first set of update parameters or query tool 68a to find and update one or more segmented utilities generated from a given survey project. The parameters of the first set of update parameters 68a may include, but are not limited to, the utility segment identification number, the update type as to whether the utility segment has been completed or un-completed, and an issuance of the update. In this same example the update interface 68 also offers a second set of update parameters or manual update tool 68b when the updated segmented utility is complete. In this part of the update interface 68, the parameters of the second set of update parameters 68b may include, but are not limited to, surveyed completion date, work type, device numbers of the devices used in the survey project, and reasoning for a manual update. Such reasons for manually updating a segmented utility line may include, but not limited to, incorrectly mapped pipeline, missing breadcrumb(s) due to a connectivity issue, reclassifying utility, correcting data entry error, surveying incorrect meter or asset type, failing to survey main utility or utility meter, missing map revisions, failing to survey due to traffic, and other various reasons as to why a manual update is required.

Having now discussed the features and components of the inspection protocol 10, methods of using the inspection protocol 10 are now discussed in greater detail below.

Prior to surveying a plot, plat, or designated area for a desired conveyance being carried or conveyed by a utility, the surveyor or technician of inspection system 1 must first set up the inspection system 1 based on the survey project. Initially, surveyor connects the utility detector 2 to the mobile device 6 in order for the utility detector 2 to output one or more conveyance readings to the mobile device 6 during the surveying operation. Upon such connection, the communication between the mobile device block 22 of the collecting program 20 and the utility detector block 24 of the collecting program 20 is complete and ready for surveying operation. Prior to or subsequent to the connection of the utility detector 2 and the mobile device 6, surveyor also connects the GPS unit 4 to the mobile device 6 in order for the GPS unit 4 to output one or more geolocations of one or more respective conveyance reading to the mobile device 6 during the surveying operation. Upon such connection, the communication between the mobile device block 22 of the collecting program 20 and the GPS unit block 26 of the collecting program 20 is complete and ready for surveying operation.

Once the utility detector 2 and the GPS unit 4 are connected with the mobile device 6, surveyor may then calibrate the utility detector 2 and the GPS unit 4 based on the given survey project. At this stage, the surveyor accesses the database 30, via mobile device 6, through the API 28 of the collecting program 20. Particularly, the operator selects or inputs a known or specific code or identification number into API 28 that is specific to the given survey project. Once the given survey project is selected, API 28 may access and load survey calibration parameters into the utility detector block 24 and the GPS unit block 26 that matches with the given survey project to collect conveyance readings and geolocations of each conveyance readings based on the given survey project. In the present embodiment, the utility detector block 24 is loaded with certain parameters for collecting natural gas readings and levels near and/or proximate to a utility that is being surveyed and carrying natural gas. Additionally, the recording of the natural gas levels with utility detector 2 would occur at a given sample rate or time intervals calibrated into the utility detector 2 so that the surveyor is required to traverse the utility line at a given speed or pace for desired measurements based on the given survey project; such calibration of the sample rate is also loaded into the GPS unit block 26 to match with the sample rate of the utility detector block 24. Once the utility detector 2 and GPS unit 4 are calibrated, the surveyor may then survey a utility line.

Referring FIGS. 1A-1E, the operator performs a survey along a desired utility that is carrying or conveying a conveyance to measure for any conveyance leaks or conveyance irregularities that may be escaping from the utility. As best seen in FIG. 1A, utility “L” is located below a ground surface “G” in which the operator “OP” is surveying with inspection system 1. Initially, operator may begin a starting point or location 70 to start the survey process; such marking of the starting point 70 is denoted by curved lines labeled “S_{SL}” that extends from the GPS unit 4 in FIG. 1A. It should be noted that such marking of a starting point or location in the drawings is for diagrammatic purposes only as to merely signify where the operator begins the surveying operations; such starting point is determined by the operator as to where he/she would like to being such surveying based on the given surveying project at hand. Additionally, GPS unit 4 used in inspection system 1 is capable of automatically locating the geolocation or position of the operator and the inspection system 1 in a given area at the starting point.

Continuing to FIGS. 1B and 1C, the operator is shown traversing along the utility “L” from the starting point 70 while the inspection system 1 collects and measures conveyance readings and geolocations of said conveyance readings based on the sampling rate calibrated to the utility detector 2 and the GPS unit 4. As best seen in FIG. 1C, utility detector 2 measures and records a first conveyance reading along the utility “L” while the GPS unit 4 measures and records a first geolocation 71b that matches the location of the first conveyance reading. As seen in FIG. 1C, such first reading performed by the utility detector 2 is denoted by dashed lines labeled “R1”, and such first measurement performed by the GPS unit 4 is denoted by rounded lines labeled “S1” herein. For diagrammatic purposes, the first conveyance reading and the first geolocation are correlated into a single measurement and is shown as a first breadcrumb 72a in FIG. 1C; such correlation and generation of the first breadcrumb 72a by the processing server 42 is discussed in greater detail below. In addition, the first breadcrumb 72a is also a first distance 74a away from the starting point 70 that may be used for analysis by processing program 40 to generate an accurate location of the conveyance reading.

Continuing to FIGS. 1D-1E and FIG. 7A, the same operation is used with respect to collecting and measuring second, third, and fourth conveyance readings (denoted “R2”, “R3”, and “R4” in FIGS. 1D-1E and FIG. 7A) and second, third, and fourth geolocations (denoted “S2”, “S3”, and “S4” in FIGS. 1D-1E and FIG. 7A) based on the sampling rate calibrated to the utility detector 2 and the GPS unit 4. Similar to the collecting the first conveyance reading and first geolocation shown in FIG. 1C, utility detector 2 measures and records second, third, and fourth conveyance readings along the utility “L” while the GPS unit 4 measures and records second, third, and fourth geolocations that match the locations of the second, third, and fourth conveyance readings. For diagrammatic purposes, the second conveyance reading and the second geolocation are correlated into a single measurement and is shown as a second breadcrumb 72b in FIG. 1D, the third conveyance reading and the third geolocation are correlated into a single measurement and is shown as a third breadcrumb 72c in FIG. 1E, and the fourth conveyance reading and the fourth geolocation are correlated into a single measurement and is shown as a fourth breadcrumb 72d in FIG. 1E; such correlation and generation of the second, third, and fourth breadcrumbs 72b, 72c, 72d by the processing server 42 is discussed in greater detail below. In addition, the second breadcrumb 72b is measured at a second distance 74b away from the starting point 70, the third breadcrumb 72c is measured at a third distance 74c away from the starting point 70, and the fourth breadcrumb 72d is measured at a fourth distance 74d away from the starting point 70 which may be used for analysis by processing program 40 to generate an accurate location of the conveyance readings.

It should be noted that such conveyance readings collected by the utility detector 2 are generated with an indicator by the processing program 40 that indicates the measured conveyance level or concentration relative to a conveyance measurement threshold. In one instance, and as best seen in FIGS. 1B-1E and 7B, one or more breadcrumb of the set of breadcrumbs 72 collected along the utility “L” may have a first utility identifier 73a that indicates that the measured conveyance level or concentration is less than the conveyance measurement threshold. In this instance, the first utility identifier 73a may signify a first gas level or concentration that is below or less than a gas measurement threshold indicating that such measurement is safe and does not pose a harm in the area.

In another instance, and as best seen in FIG. 7B, one or more breadcrumb of the set of breadcrumbs 72 collected along the utility “L” may have a second utility identifier 73b that indicates that the measured conveyance level or concentration is equal to or greater than the conveyance measurement threshold. In this instance, the second utility identifier 73b may signify a second gas level or concentration that is equal to or greater than a gas measurement threshold indicating that such measurement is unsafe and may pose as a harm in the area. In this instance, a crack or similar utility line anomaly 75 is shown in FIG. 7B in which gas may escape from the utility line leading to this elevated gas level or concentration.

In yet another instance, and as best seen in FIG. 7C, one or more breadcrumb of the set of breadcrumbs 72 collected along the utility “L” may have a third utility identifier 73c that indicates that the measured conveyance reading or geolocation has an error. In these instances, such error may arise when the GPS unit 4 is unable to record geolocation data due to surrounding obstructions, including heavy tree cover proximate to the surveyed utility line, proximate to high voltage power lines, below or under a manmade structure (e.g., bridge or tunnel), and other similar obstructions that may impede or cause errors with respect to recording geolocation data. In one example, and as best seen in FIG. 7C, a tree or vegetation obstruction (labeled “T” in FIG. 7C) is shown blocking or impeding the capabilities of the GPS unit 4 from recording and collecting a geolocation underneath said vegetation obstruction which, in turn, result in the third utility identifier 73c.

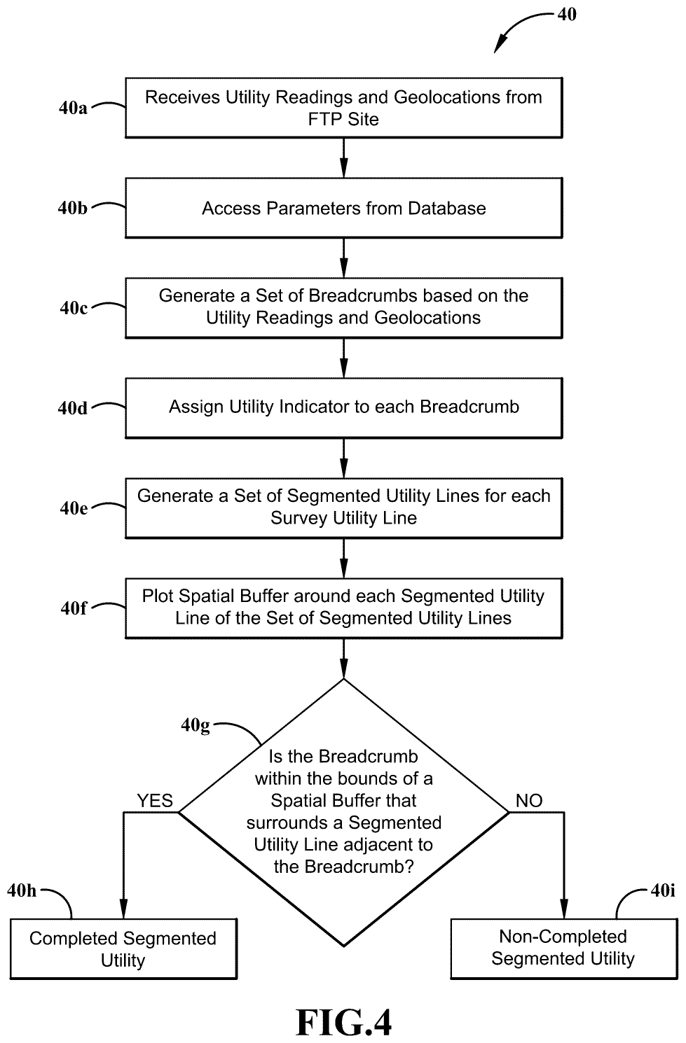

Once the surveying operation is completed by the operator, the data collected, particularly the conveyance readings measured by the utility detector 2 and geolocations measured by the GPS unit 4, is output from blocks 24, 26, to the mobile device block 22, and then to the FTP site 32. At this stage, processing program 40 may be executed to receive the data collected by the collecting program 20. Particularly, processing server 42 of the processing program 40 receives the data collected by the utility detector 2 and the GPS unit 4, via the FTP site server 32, to further process and generate such conveyance readings measured by the utility detector 2 and such geolocations measured by the GPS unit 4 into the set of breadcrumbs 72 discussed previously; such instruction or step of processing program 40 is denoted as step 40a in FIG. 4.

Concurrently, processing server 42 may also access the database 30 of collecting program 20 for information that may be assigned to each breadcrumb of the set of breadcrumbs 72. Such information that may be accessed by processing server 42 includes operator or crewmember information that was inputted by the operator during the survey operation, device identification information relating to the utility detector 2 and the GPS unit 4, calendar date or dates of the survey, the conveyance measurement threshold, the sampling rate and/or time intervals at which the utility detector 2 and the GPS unit 4 survey and record measurements, and other information that was inputted by the operator or installed into the database 30 for a specific survey project. Such instruction or step of processing program 40 is denoted as step 40b in FIG. 4. Further, one or more pieces of information accessed by the processing server 42 may also be searched by users or customers during the querying program 60 to quickly find and see one or more desired breadcrumbs of the set of breadcrumbs 72 in a given survey project; such operation of the querying program 60 is discussed in further detail below.

Upon such completion of steps 40a and 40b, the processing server 42 correlates each conveyance reading measured by the utility detector 2 with a corresponding or matching geolocation of said conveyance reading measured by the GPS unit 4 to generate a set of breadcrumbs 72. As best seen in FIGS. 1B-1E and FIGS. 7A-7C, processing server 42 generates a first breadcrumb 72a, second breadcrumb 72b, third breadcrumb 72c, fourth breadcrumb 72d, fifth breadcrumb 72e, sixth breadcrumb 72f, and any remaining breadcrumbs based on a finite number of conveyance readings and geolocations recorded by the utility detector 2 and GPS unit 4. Such instruction or step of processing program 40 is denoted as step 40c in FIG. 4.

During the processing operation, processing server 42 may also attach, assign, or indicate each breadcrumb of the set of breadcrumbs 72 with an indicator or identifier based on the conveyance measurement threshold installed into inspection protocol 10. In one instance, and as best seen in FIGS. 1B-1E and 7A, the first breadcrumb 72a, second breadcrumb 72b, third breadcrumb 72c, and fourth breadcrumb 72d are each assigned with a first conveyance or safe identifier 73a signifying a first gas level or concentration that is below or less than a gas measurement threshold indicating that such measurement is safe and does not pose a harm in the area. As discussed in greater detail below, such first identifier 73a assigned to each of the first breadcrumb 72a, second breadcrumb 72b, third breadcrumb 72c, and fourth breadcrumb 72d is then generated on a tangible report or medium to easily view areas that are safe and/or free of further investigation given such safety. In another instance, and as best seen in FIG. 7B, a fifth breadcrumb 72e may be assigned with a second conveyance or warning identifier 73b signifying a second gas level or concentration that is equal to or greater than a gas measurement threshold indicating that such measurement is unsafe and does pose a harm in the area. As discussed in greater detail below, such second identifier 73b assigned to the fifth breadcrumb 72e is then generated on the tangible report or medium to easily view areas that are unsafe and may need further investigation given such safety. In another instance, and as best seen in FIG. 7C, a sixth breadcrumb 72f may be assigned with a third conveyance or error identifier 73c signifying that such measurement includes an error and cannot be generated (e.g., missing or error in conveyance reading and/or missing or error in geolocation). As discussed in greater detail below, such third identifier 73c assigned to the sixth breadcrumb 72f is then generated on the tangible report or medium in order to easily view areas that need further investigation due to such error measurement that occurred during the survey operation. Such step or instruction of assigning indicator to respective breadcrumbs is denoted as step 40d in FIG. 4.

Processing server 42 also processes and/or generates a set of segmented utilities 76 based on the utility “L” surveyed during the execution of the collecting program 20. As best seen in FIG. 7D, processing server 42 cuts and/or segments the utility “L” into the set of utilities 76 in order to correlate and match adjacent or proximate breadcrumbs of the set of breadcrumbs 72 to validate the survey project of the utility “L”. Such generation of the set of segmented utilities 76 may be based on predetermined lengths that are installed into the database 30 for the given survey project. Examples of suitable lengths in which the processing server 42 may generate each segmented utility line of a set of segmented utilities include five feet, ten feet, twenty five feet, fifty feet, and other suitable lengths in which the processing server 42 may generate each segmented utility line of a set of segmented utilities. It should be noted that while each segmented utility line of the set of segmented utilities 76 is shown spaced apart from one another, one or more adjacent segmented utility line of the set of segmented utilities 76 may overlap one another. Such step or instruction of segmenting a surveyed utility line is denoted as step 40e in FIG. 4.

In other exemplary embodiments, the step 40e of processing program 40 may be executed by a processor of inspection system 1 at other stages of processing program 40. In one example, and as preferred by the inventors herein, step 40e may be executed prior to steps 40a-40d in which one or more utilities that are intended to be surveyed are broken into sets of segmented utilities 76 prior to such utilities being surveyed. Therefore, step 40e may be executed by the processor of inspection system 1 prior to the execution of steps 40a-40d if desired.

Upon generating the set of breadcrumbs 72 and the set of segmented utilities 76, processing server 42 may then combine the set of breadcrumbs 72 and the set of segmented utilities 76 to generate a plot of the surveyed utility line. As best seen in FIG. 7D, processing server 42 places each breadcrumb of the set of breadcrumbs 72 on a map that includes the set of segmented utilities 76. It should be noted that this stage, the indicators 73 may or may not be shown for each breadcrumb of the set of breadcrumbs 72 until the set of segmented utilities 76 are validated based on spatial distances between the set of breadcrumbs 72 and the set of segmented utilities 76; such validation is discussed in greater detail below.

Once the set of breadcrumbs 72 is plotted near respective segmented utilities of the set of segmented utilities 76, processing server 42 may then validate and/or complete each segmented utility of the set of segmented utilities 76 based on the proximity and/or spatial distance from at least one breadcrumb of the set of breadcrumb 72 collected during the surveying operation. As best seen in FIG. 7E, processing server 42 applies a spatial buffer or boundary 78 around each segmented utilities of the set of segmented utilities 76 to validate and/or complete each segmented utilities of the set of segmented utilities 76 based at least one breadcrumb 72 collected during the collecting program 20. It should be understood that each spatial buffer 78 surrounding a respective segmented utility lines of the set of segmented utility lines 76 is set at a buffer distance “B” measured from the respective segmented utility. Such buffer distance or dimension is a predetermined distance based on a given survey project in order to validate breadcrumbs 72 in the inspection protocol 10. Such step or instruction of applying spatial buffers 78 is denoted as step 40f in FIG. 4.

In other exemplary embodiments, the step 40f of processing program 40 may be executed by a processor of inspection system 1 at other stages of processing program 40. In one example, step 40f may be executed prior to steps 40a-40d and subsequent to step 40e in which the spatial buffers are applied around each segmented utility of the sets of segmented utility 76 prior to such utilities being surveyed. Therefore, step 40f may be executed by the processor of inspection system 1 prior to the execution of steps 40a-40d while still being executing subsequent to step 40e if desired.

As best seen in FIG. 7G, processing server 42 may complete or validate one or more segmented utilities of the set of segmented utilities 76 based on the proximity of at least one breadcrumb 72 inside a respective spatial buffer 78; such step or instruction of completing one or more segmented utilities of the set of segmented utilities 76 is denoted as step 40g in FIG. 4. In one example, a first spatial buffer 78a surrounds a first segmented utility line 76a of the set of segmented utilities 76. In this example, the first breadcrumb 72a is positioned inside of the first spatial buffer 78a based on a first distance measured between the first breadcrumb 72a and the first segmented utility line 76a; such first distance measured between the first breadcrumb 72a and the first segmented utility line 76a is denoted by a double arrow labeled “B1” in FIG. 7G. In this example, the first distance “B1” is less than the buffer distance “B” thus seating the first breadcrumb 72a inside of the first spatial buffer 78a and completing and/or validating the first segmented utility line 76a by the processing server 42; such completion of the first segmented utility line 76a is also denoted by a checkmark symbol shown in FIG. 7G and is shown in step 40h.

Similarly, a second spatial buffer 78b surrounds a second segmented utility 76b of the set of segmented utilities 76. In this example, the second breadcrumb 72b is positioned inside of the second spatial buffer 78b based on a second distance measured between the second breadcrumb 72b and the second segmented utility line 76b; such second distance measured between the second breadcrumb 72b and the second segmented utility line 76b is denoted by a double arrow labeled “B2” in FIG. 7G. In this example, the second distance “B2” is also less than the buffer distance “B” thus seating the second breadcrumb 72b inside of the second spatial buffer 78b and completing and/or or validating the second segmented utility line 76b by the processing server 42.

In this same example, processing server 42 may also invalidate and/or keep one or more segmented utilities of the set of segmented utilities 76 as non-complete. As best seen in FIG. 7G, the third breadcrumb 72c is positioned outside of the third spatial buffer 78c based on a third distance measured between the third breadcrumb 72c and the third segmented utility line 76c; such third distance measured between the third breadcrumb 72c and the third segmented utility line 76c is denoted by a double arrow labeled “B3” in FIG. 7G. In this example, the third distance “B3” is greater than the buffer distance “B” thus seating the third breadcrumb 72c outside of the third spatial buffer 78c and invalidating and/or maintaining the third segmented utility 76c as non-complete by the processing server 42; the act of non-validating and not completing the third segmented utility 76c is denoted by a cross or “X” labeled in FIG. 7G and is shown in step 40i. In this operation, the third segmented utility 76c is left non-completed and/or unfinished in the set of segmented utility until the third segmented utility 76c is resurveyed.

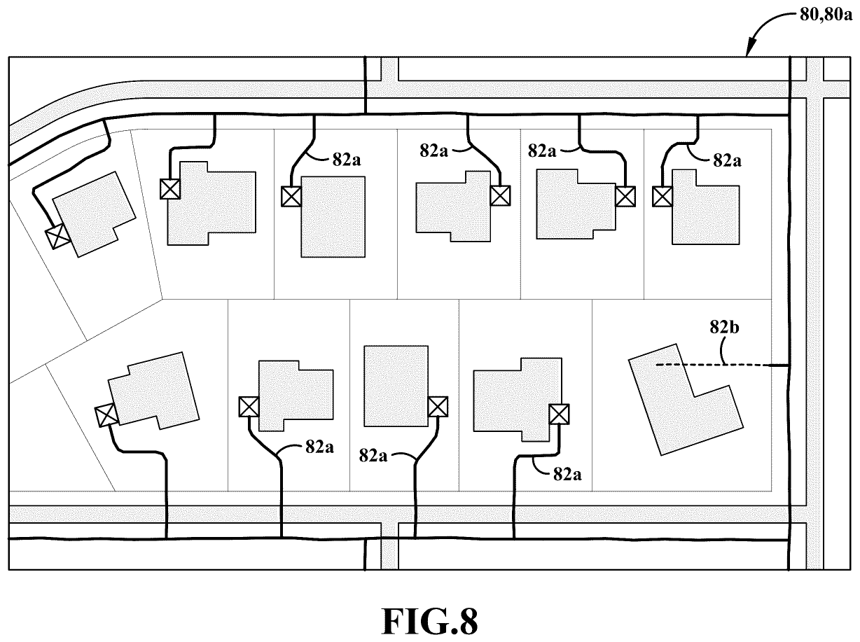

Upon such validation, processing server 42 may output at least one tangible report or medium 80 that is viewable by a customer or operator of the inspection protocol 10. As best seen in FIG. 8, processing server 42 may output a first tangible report or medium 80a that displays surveyed utilities that have been validated lines 82a or invalidated lines 82b by processing program 40 in previous survey operations. In FIG. 8, all surveyed utilities that have been validated (i.e., survey was completed) by the processing program 40 are denoted by a solid line labeled 80b. Still referring to FIG. 8, all surveyed segmented utilities that have been left non-completed and/or unfinished by the processing program 40 are denoted by a dashed line labeled 80b.

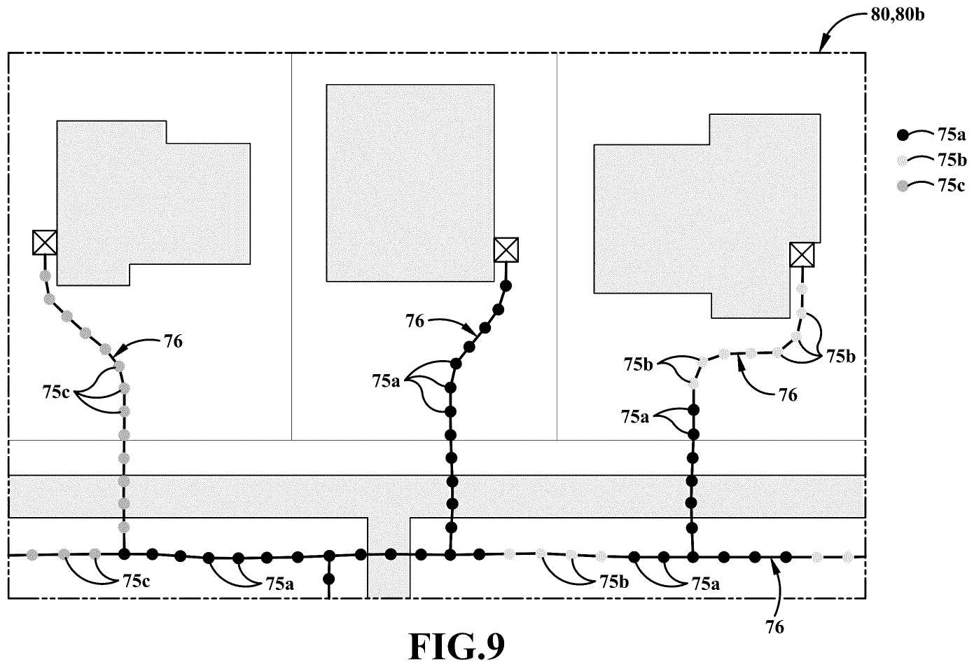

Now referring to FIG. 9, processing server 42 may also output a second tangible report or medium 80b that displays surveyed utilities that have been validated by processing program 40 as well as validated breadcrumbs collected from previous survey operations. In FIG. 9, processing server 42 may display the indicators 73 for each breadcrumb 72 noted on the tangible report 80b. Specifically, the first identifier 73a, the second indictor 73b, and the third identifier 73c are shown based on the conveyance reading measured by the utility detector 2 during the collecting program 20.

It should be noted that all information generated by processing server 42 is then outputted to the processed files server 44 and the archive server 46.

Upon such completion of the processing program 40, the querying program 60 may be executed and used to find or locate data or information specific to a given survey project. As discussed previously, users of querying program 60 may input one or more parameters into the querying server 62 to locate one data or information specific to a given survey project, such as specific breadcrumbs 72, specific segmented utilities 76, information relating to a specific crewmember or user, information relating to a specific conveyance measurement of value, information relating the dates of survey, and other parameters mentioned above. Upon such inputs, querying server 62 is capable of accessing the collecting program 20 and the processing program 40 to retrieve and display information that relates to the parameters inputted by the user. If, however, one or more errors are shown by the querying server 62, the user may manually adjust or update one or more errors that relates to a specific segmented utility line or a specific breadcrumb.

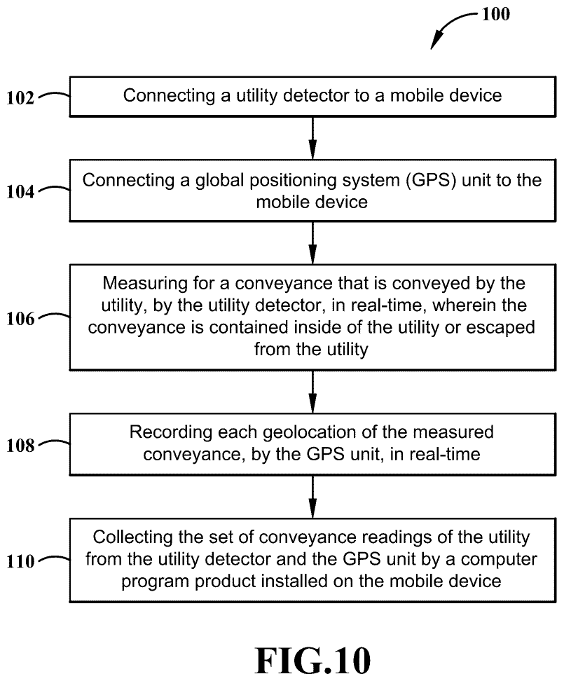

FIG. 10 is a method 100 of collecting a set of conveyance readings along a utility. An initial step 102 of method 100 includes connecting a utility detector to a mobile device. Another step 104 of method 100 includes connecting a global positioning system (GPS) unit to the mobile device. Another step 106 of method 100 includes measuring for a conveyance that is conveyed by the utility line, by the utility detector, in real-time, wherein the conveyance is contained inside of the utility or escaped from the utility. Another step 108 of method 100 includes recording each geolocation of the measured conveyance, by the GPS unit, in real-time. Another step 110 of method 100 includes collecting the set of conveyance readings of the utility from the utility detector and the GPS unit by a computer program product installed on the mobile device.

In other exemplary embodiments, method 100 may include additional or optional steps of collecting a set of conveyance readings along a utility. In one exemplary embodiment, method 100 may further include that the step of measuring for the conveyance that is carried inside of the utility, by the utility detector, in real-time further includes that the measuring the utility that is carried inside of the utility is performed at a predetermined time interval prior to measuring said conveyance; and wherein the step of recording each geolocation of the measured conveyance, by the GPS unit, in real-time further includes that the recording of the measured conveyance is performed at the predetermined time interval prior to recording each geolocation. In another exemplary embodiment, method 100 may further include that the step of measuring for the conveyance that is carried inside of the utility, by the utility detector, in real-time further includes that the measuring the conveyance that is carried inside of the utility is performed at a starting point prior to measuring said conveyance; and wherein the step of recording each geolocation of the measured conveyance, by the GPS unit, in real-time further includes that the recording of the measured conveyance is performed at the predetermined starting point prior to recording each geolocation. In another exemplary embodiment, method 100 may further include steps of selecting a utility project from the computer program product installed on the mobile device; saving measured conveyance readings and geolocations to the selected utility project. In another exemplary embodiment, method 100 may further include steps of accessing application programming interface (API) from the mobile device; and accessing a database having a set of conveyance parameters related to the selected utility project. In another exemplary embodiment, method 100 may further include a step of recording a profile of an inspector on the API from the mobile device that is operating the utility detector and the GPS unit. In another exemplary embodiment, method 100 may further include a step of setting the utility detector to a conveyance measurement threshold based on the selected utility project. In another exemplary embodiment, method 100 may further include a step of setting time intervals of the collected conveyance readings based on the selected utility project. In another exemplary embodiment, method 100 may further include a step of outputting a data set to a file transfer protocol server, wherein the data set includes each conveyance reading of the set of conveyance readings and each geolocation associated with a respective conveyance reading of the set of conveyance readings. In another exemplary embodiment, method 100 may further include that the step of measuring for the conveyance that is carried inside of the utility further includes that the conveyance is one of gas, water, or electricity.

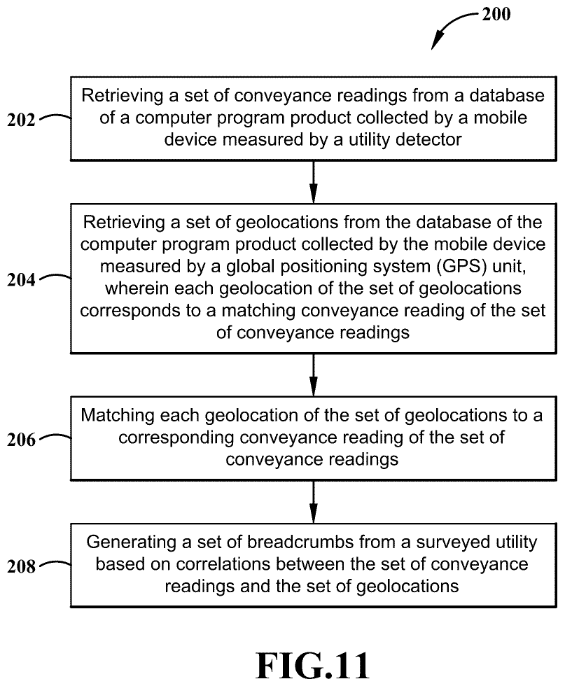

FIG. 11 is a method 200 of processing a set of collected conveyance readings of a utility. An initial step 202 of method 200 includes retrieving a set of conveyance readings from a database of a computer program product collected by a mobile device measured by a utility detector. Another step 204 of method 200 includes retrieving a set of geolocations from the database of the computer program product collected by the mobile device measured by a global positioning system (GPS) unit, wherein each geolocation of the set of geolocations corresponds to a matching conveyance reading of the set of conveyance readings. Another step 206 of method 200 includes matching each geolocation of the set of geolocations to a corresponding conveyance reading of the set of conveyance readings. Another step 208 of method 200 includes generating a set of breadcrumbs along a surveyed utility based on correlations between the set of conveyance readings and the set of geolocations.

In other exemplary embodiments, method 200 may include additional or optional steps of processing a set of collected conveyance readings of a utility. In one exemplary embodiment, method 200 may further include a step of dividing the surveyed utility into a set of segmented utilities based on a predetermined length by the computer program product. In another exemplary embodiment, method 200 may further include steps of applying a spatial buffer around each segmented utility line of the set of segmented utilities; and determining a spatial location of at least one breadcrumb of the set of breadcrumbs relative to a boundary of the spatial buffer. In another exemplary embodiment, method 200 may further include a step of completing each segmented utility line of the set of segmented utilities when at least one breadcrumb is interior to the boundary of the spatial buffer. In another exemplary embodiment, method 200 may further include a step of maintaining each segmented utility line of the set of segmented utilities as incomplete when at least one breadcrumb is exterior to the boundary of the spatial buffer. In another exemplary embodiment, method 200 may further include that each incomplete segmented utility line is re-surveyed. In another exemplary embodiment, method 200 may further include a step of indicating each breadcrumb of the set of breadcrumbs with an identifier, by the computer program product, that is measured relative to a conveyance measurement threshold. In another exemplary embodiment, method 200 may further include that the step of indicating each breadcrumb of the set of breadcrumbs with the identifier measured further includes a safe identifier when the respective conveyance reading is less than the conveyance measurement threshold. In another exemplary embodiment, method 200 may further include that the step of indicating each breadcrumb of the set of breadcrumbs with the identifier measured further includes a danger identifier when the respective conveyance reading is greater than the conveyance measurement threshold. In another exemplary embodiment, method 200 may further include that the step of indicating each breadcrumb of the set of breadcrumbs with the identifier measured further includes an error identifier when the respective conveyance reading incurs an error. In another exemplary embodiment, method 200 may further include a step of outputting the set of breadcrumbs to an archive of the computer program product. In another exemplary embodiment, method 200 may further include steps of inputting known breadcrumbs of a known set of breadcrumbs; and correlating the known set of breadcrumbs with the set of breadcrumbs to generate a second report.

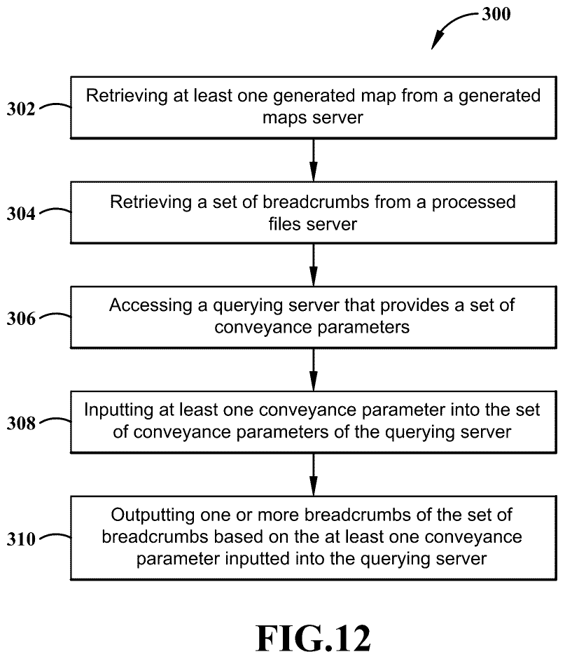

FIG. 12 is a method 300 of searching a set of collected conveyance readings of a utility. An initial step 302 of method 300 includes retrieving at least one generated map from a generated maps server. Another step 304 of method 300 includes retrieving a set of breadcrumbs from a processed files server. Another step 306 of method 300 includes accessing a querying server that provides a set of conveyance parameters. Another step 308 of method 300 includes inputting at least one conveyance parameter into the set of conveyance parameters of the querying server. Another step 310 of method 300 includes outputting one or more breadcrumbs of the set of breadcrumbs based on the at least one conveyance parameter inputted into the querying server.

In other exemplary embodiments, method 300 may include additional or optional steps of searching a set of collected conveyance readings of a utility. In one exemplary embodiment, method 300 may further include that the step of inputting the at least one conveyance parameter into the set of conveyance parameters of the querying server further comprises: inputting a first conveyance measurement threshold into the querying server that relates to a primary conveyance measurement threshold stored in a computer program product; and inputting a second conveyance measurement threshold into the querying server that relates to the primary conveyance measurement threshold stored in the computer program product; wherein the second conveyance measurement threshold is greater than the first conveyance measurement threshold. In another exemplary embodiment, method 300 may further include that the first conveyance measurement threshold input into the querying server is less than the primary conveyance measurement threshold. In another exemplary embodiment, method 300 may further include that the first conveyance measurement threshold input into the querying server is equal to or greater than the primary conveyance measurement threshold. In another exemplary embodiment, method 300 may further include a step of updating at least one breadcrumb with corrected information by an update server of the computer program product when the at least one breadcrumb includes an error. In another exemplary embodiment, method 300 may further include a step of updating the at least one segmented utility line with corrected information by a manual update tool of the computer program product. In another exemplary embodiment, method 300 may further include that the step of updating the at least one segmented utility line with the corrected information further includes: inputting whether the at least one segmented utility line is complete or un-complete; and selecting a manual update reason from a plurality of manual update reasons when the at least one segmented utility line is complete. In another exemplary embodiment, method 300 may further include that the step of inputting the at least one conveyance parameter into the set of conveyance parameters of the querying server further comprises: inputting a name of an inspector or a reference area.

The system of the present disclosure may additionally include one or more sensors to sense or gather data pertaining to the surrounding environment or operation of the system. Some exemplary sensors capable of being electronically coupled with the system of the present disclosure (either directly connected to the system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

The system of the present disclosure may include wireless communication logic coupled to sensors on the system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the system of the present disclosure may serve as a repeater, or the systems of the present disclosure may be connected together in a mesh network to relay signals from one system to the next. However, the individual system in this scheme typically would not have IP addresses of their own. Instead, one or more of the system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the system of the present disclosure may differ from embodiment to embodiment. In one embodiment, alerts and signals from the system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the system of the present disclosure may also be sent to a work tracking system that allows the individual, or the organization for which he or she works, to track the status of the various alerts that are received, to schedule particular workers to repair a particular system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the system of the present disclosure, and the system may be able to provide aggregate machine operational data for system of the present disclosure or group of systems of the present disclosure.

The system also allows individuals to access the system of the present disclosure for configuration and diagnostic purposes. In that case, the individual processors or microcontrollers of the system of the present disclosure may be configured to act as Web servers that use a protocol like hypertext transfer protocol (HTTP) to provide an online interface that can be used to configure the system. In some embodiments, the systems may be used to configure several systems of the present disclosure at once. For example, if several systems are of the same model and are in similar locations in the same location, it may not be necessary to configure the systems individually. Instead, an individual may provide configuration information, including baseline operational parameters, for several systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the system of the present disclosure, which may include the logic(s) presented herein, includes the features, components, techniques or processes detailed herein that, as combined, accomplished the desired results detailed herein. These specific elements, configuration or techniques of the system of the present disclosure, some of which may be included in at least one of the appended claims, accomplish these desired results to overcome the then existing problems in the relevant field of computer processor-based systems. Additionally, the features, components, techniques or processes of the system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method of searching a set of collected conveyance readings of a utility, comprising steps of:
retrieving at least one generated map from a generated maps server;
retrieving a set of breadcrumbs from a processed files server, wherein each of the set of breadcrumbs is based on a conveyance reading measured by a utility detector moved along the utility and a geolocation reading measured by a global positioning system (GPS) at a predetermined sampling rate;
accessing a querying server that provides a set of conveyance parameters;
inputting at least one conveyance parameter into the set of conveyance parameters of the querying server; and
outputting one or more breadcrumbs of the set of breadcrumbs based on the at least one conveyance parameter inputted into the querying server.

2. The method of claim 1, wherein the step of inputting the at least one conveyance parameter into the set of conveyance parameters of the querying server further comprises:
inputting a first conveyance measurement threshold into the querying server that relates to a primary conveyance measurement threshold stored in a computer program product; and
inputting a second conveyance measurement threshold into the querying server that relates to the primary conveyance measurement threshold stored in the computer program product;
wherein the second conveyance measurement threshold is greater than the first

3. The method of claim 2, wherein the first conveyance measurement threshold input into the querying server is less than the primary conveyance measurement threshold.

4. The method of claim 2, wherein the first conveyance measurement threshold input into the querying server is equal to or greater than the primary conveyance measurement threshold.

5. The method of claim 1, further comprising:
updating at least one breadcrumb with corrected information by an update server of the computer program product when the at least one breadcrumb includes an error.

6. The method of claim 1, further comprising:
updating [[the]] at least one segmented utility line with corrected information by a manual update tool of the computer program product.

7. The method of claim 6, wherein the step of updating the at least one segmented utility line with the corrected information further includes:
inputting whether the at least one segmented utility line is complete or un-complete; and
selecting a manual update reason from a plurality of manual update reasons when the at least one segmented utility line is complete.

8. The method of claim 1, wherein the step of inputting the at least one conveyance parameter into the set of conveyance parameters of the querying server further comprises:
inputting a name of an inspector or a reference area.

9. A computer program product installed on a mobile device and including one or more non-transitory machine-readable mediums encoded with instructions that, when executed by one or more processors, cause a process to search a set of collected conveyance readings of a surveyed utility line, the instructions comprising:
retrieve at least one generated map from a generated maps server;
retrieve a set of breadcrumbs from a processed files server, wherein each of the set of breadcrumbs is based on a conveyance reading measured by a utility detector moved along the utility and a geolocation reading measured by a global positioning system (GPS) at a predetermined sampling rate;
access a querying server that provides a set of conveyance parameters;
input at least one conveyance parameter into the set of conveyance parameters of the querying server; and
output one or more breadcrumbs of the set of breadcrumbs based on the at least one conveyance parameter inputted into the querying server.

10. The computer program product of claim 9, wherein the instruction to input the at least one conveyance parameter into the set of conveyance parameters of the querying server further comprises:
input a first conveyance measurement threshold into the querying server that relates to a primary conveyance measurement threshold stored in the computer program product; and
input a second conveyance measurement threshold into the querying server that relates to the primary conveyance measurement threshold stored in the computer program product;
wherein the second conveyance measurement threshold is greater than the first

11. The computer program product of claim 10, wherein the first conveyance measurement threshold input into the querying server is less than the primary conveyance measurement threshold.

12. The computer program product of claim 10, wherein the first conveyance measurement threshold input into the querying server is equal to or greater than the primary conveyance measurement threshold.

13. The computer program product of claim 9, further comprising:
update at least one breadcrumb with corrected information by an update server of the computer program product when the at least one breadcrumb includes an error.

14. The computer program product of claim 9, further comprising:
update at least one segmented utility line with corrected information by a manual update tool of the computer program product.

15. The computer program product of claim 14, wherein the instruction to update the at least one segmented utility line with the corrected information further includes:
input whether the at least one segmented utility line is complete or un-complete; and
select a manual update reason from a plurality of manual update reason when the at least one segmented utility line is complete.

16. The computer program product of claim 9, wherein the instruction to input the at least one conveyance parameter into the set of conveyance parameters of the querying server further comprises:
input a name of an inspector or a reference area.
